(19) United States
(12) Patent Application Publication
(10) Pub. No.: US 2015/0011784 A1
(43) Pub. Date: Jan. 8, 2015

(54) METHOD FOR PRODUCING FUEL OIL BASE

(71) Applicant: JX NIPPON OIL & ENERGY CORPORATION, Tokyo (JP)

(72) Inventors: Nobuo Aoki, Tokyo (JP); Hitoshi Matsuda, Tokyo (JP); Hiroaki Kato, Tokyo (JP); Akira Yoneda, Tokyo (JP); Ryo Arashida, Tokyo (JP); Yuka Marukawa, Tokyo (JP)

(21) Appl. No.: 14/375,549

(22) PCT Filed: Jan. 28, 2013
(86) PCT No.: PCT/JP2013/051772

§ 371 Date: Jul. 30, 2014

(30) Foreign Application Priority Data
Jan. 31, 2012 (JP) 2012-018994

(51) Int. Cl. C11C 1/04

(52) U.S. Cl. CPC C11C 1/045
USPC 554/1; 435/134

(57) ABSTRACT

A method for producing a fuel oil base, comprising: a first step of aerobically culturing a microalga Euglena under a nitrogen-deficient condition; a second step of adding a nutrient to a treatment solution containing the microalga Euglena cultured in the first step, adjusting the dissolved oxygen concentration of the treatment solution to 0.03 mg/L or less, and performing anaerobic fermentation of the microalga Euglena to produce a wax ester; and a third step of hydrotreating a raw material oil containing the wax ester to produce a fuel oil base.

### TECHNICAL FIELD

The present invention relates to a method for producing a fuel oil base.

### BACKGROUND ART

In recent years, global warming issues have been coming to the fore, and suppression of the emission of carbon dioxide gas which is one of greenhouse gases and a reduction in the concentration of carbon dioxide in the air by fixing carbon dioxide are big problems. Under such a circumstance, use of fossil fuels containing fixed carbon dioxide as energy leads to discharging the fixed carbon dioxide to the air again, causing environmental problems. The fossil fuel is a limited resource, leading to a problem of exhaustion.

To solve such problems, fuel resources other than the fossil fuels are needed, and development of biofuels using higher plants and algae as a raw material has been increasingly expected.

As the candidate higher plants for the biofuel raw material, soybean, corn, palm, and the like are known; in the case where such edible crops are used as a raw material, a scarcity of food is concerned. Although production of the biofuels from inedible plants such as Jatropha Curcas and Camelina sativa has been advanced, these inedible plants have a problem of a small amount of fuel production per unit area.

In contrast, photosynthetic microorganisms and protozoa living widely in ponds and marshes have the same photosynthetic ability as the plants, and these photosynthetic microorganisms and protozoa biosynthesize carbohydrate and lipid from water and carbon dioxide, and accumulate a few tens % by mass of these inside the cells. The production amount thereof is higher than that of the higher plants; for example, it is known that the photosynthetic microorganisms and protozoa achieve the production amount per unit area 10 times or more that of the palm.

A microalga Euglena, which is one of the photosynthetic microorganisms, belongs to flagellates, and includes Euglena gracilis famous as a mobile alga.

Euglena is a genus classified both in zoology and in botany. In zoology, Euglena is classified into the order: Euglenida which belongs to the plant flagellate subclass: Phytomastigophorea, the flagellate class: Mastigophorea, the phylum: Protozoa; and Euglenida comprises three suborders, Euglenoidina, Peranemoidina, and Petalomonadoidina. Euglenoidina includes Euglena, Trachelemonas, Strombonas, Phacus, Lepocinelis, Astasia, and Colacium as genuses. In botany, Euglena is classified into the order: Euglenales, the class: Euglenophyceae, the division: Euglenophyta; and Euglenales includes Euglena and the same genuses as those in the classification in zoology.

Euglena accumulates paramylon as a carbohydrate inside the cells. Paramylon is a polymer particle produced by polymerization of approximately 700 glucose molecules through β-1,3-bond.

Patent Literature 1 discloses a method for producing a wax ester utilizing conversion of stored polysaccharide paramylon to a wax ester by a fermentation phenomenon when Euglena is kept under an anaerobic condition.

### CITATION LIST

### Patent Literature

Patent Literature 1: Japanese Examined Patent Publication No. 3-65948

### SUMMARY OF INVENTION

### Technical Problem

The main components of vegetable oils and fats derived from typical algae are oils and fats having a main skeleton having 16 or more carbon atoms, and such a number of carbon atoms corresponds to that of gas oil or petroleum fractions heavier than gas oil. The wax ester produced by the anaerobic fermentation of Euglena comprises fatty acid and alcohol having 14 carbon atoms mainly. For this reason, a fuel oil base for an aviation fuel, whose number of carbon atoms is in the range of 10 to 16, can be easily produced from the wax ester derived from Euglena.

In the anaerobic fermentation of Euglena, diglyceride and triglyceride are produced in addition to the wax ester; these oils and fats are oils and fats having 16 or more carbon atoms, leading to a problem of difficulties in application in production of a fuel oil base for an aviation fuel.

An object of the present invention is to provide a method for producing a fuel oil base that can produce a wax ester from a microalga Euglena with high efficiency to produce a fuel oil base suitable for an aviation fuel efficiently. Another object of the present invention is to provide a fuel oil base produced by the above production method, a fuel oil composition including the fuel oil base, and a method for producing the fuel oil composition.

### Solution to Problem

A first aspect according to the present invention relates to a method for producing a fuel oil base, comprising a first step of aerobically culturing a microalga. Euglena under a nitrogen-deficient condition; a second step of adding a nutrient to a treatment solution containing the microalga Euglena cultured in the first step, adjusting a dissolved oxygen concentration of the treatment solution to 0.03 mg/L or less, and performing anaerobic fermentation of the microalga Euglena to produce a wax ester; and a third step of hydrotreating a raw material oil containing the wax ester to produce a fuel oil base.

In the production method, an amount of paramylon accumulated in the microalga Euglena can be increased by aerobically culturing the microalga Euglena under a nitrogen-deficient condition in the first step.

However, according to the knowledge of the present inventors, when the microalga Euglena cultured in the first step is used, the amount of accumulated paramylon which is the raw material for the wax ester is increased, but the efficiency of the wax ester production in the anaerobic fermentation is reduced so that the proportion of the wax ester to diglyceride and triglyceride remains a low level. As described above, because diglyceride and triglyceride both have 16 or more carbon atoms, these are difficult to use in production of the fuel oil base for an aviation fuel.

To solve the problem, in the second step in the production method, a nutrient is added to the treatment solution containing the microalga Euglena cultured in the first step. The nutrient is added to the treatment solution before the dissolved oxygen concentration of the treatment solution is adjusted to 0.03 mg/L or less for the anaerobic fermentation; thereby, the efficiency of the wax ester production in the anaerobic fermentation of the microalga Euglena can be significantly improved.

Namely, in the production method, the amount of paramylon accumulated in the microalga Euglena can be increased in the first step, and the problem caused in the first step can be eliminated in the second step to improve the efficiency of the wax ester production in the anaerobic fermentation, thereby producing the wax ester efficiently. The wax ester produced through the first step and the second step comprises fatty acid and alcohol having 14 carbon atoms mainly as described above; for this reason, a fuel oil base suitable for an aviation fuel can be easily produced from the wax ester with high efficiency.

It is thought that the effect of the second step is attained for the following reason. First, because the enzyme related to the anaerobic fermentation is protein, a nutrient for biosynthesizing amino acid that forms protein is needed. It is thought that because the first step is performed under a nitrogen-deficient condition, a new nutrient (particularly a nitrogen source) is difficult to feed to the microalga Euglena from the outside; as a result, the amount of the enzyme related to the generation of the wax ester produced in the microalga Euglena is reduced, reducing the efficiency of the wax ester production. It is thought that the production of the enzyme is promoted by adding the nutrient in the second step to improve the efficiency of the wax ester production.

The second step may be a step of adjusting the dissolved oxygen concentration of the treatment solution to 0.03 mg/L or less within 3 hours after the nutrient is added to the treatment solution.

If the nutrient is added 3 hours before the dissolved oxygen concentration of the treatment solution is adjusted to 0.03 mg/L or less, the nutrient can be prevented from being consumed before the anaerobic fermentation, and the amount of the enzyme produced which is related to the generation of the wax ester can be more securely increased to improve the efficiency of the wax ester production more significantly.

It is preferable that the nutrient contain a nitrogen source. By adding the nutrient containing a nitrogen source, the amount of the enzyme produced which is related to the generation of the wax ester can be increased more securely to improve the efficiency of the wax ester production more significantly.

It is preferable that the nitrogen source contain an ammonium compound. By adding the nutrient containing such a nitrogen source, the amount of the enzyme produced which is related to the generation of the wax ester can be increased more securely to improve the efficiency of the wax ester production more significantly. The ammonium compound is advantageous in availability and cost.

The nutrient may contain a carbon source. The nutrient may contain a nitrogen source and a carbon source.

It is preferable that the carbon source contain glucose. The nutrient containing glucose as the carbon source has a high effect of improving the efficiency of the wax ester production, and is advantageous in availability and cost.

The third step may be a step including a hydrorefining treatment and a hydroisomerization treatment as thehydrotreatment. By performing the hydrorefining treatment and the hydroisomerization treatment, the proportion of isoparaffin contained in the fuel oil base can be increased to improve low temperature performance.

A second aspect according to the present invention relates to a fuel oil base produced by the production method.

A third aspect according to the present invention relates to a method for producing a fuel oil composition, comprising a step of producing a fuel oil composition having a sulfur content of 10 mass ppm or less and a freezing point of −47° C. or less using the fuel oil base produced by the production method.

The content of the fuel oil base in the fuel oil composition can be 1 to 50% by volume.

The fuel oil composition may contain at least one additive selected from an antioxidant, an antistatic agent, a metal deactivator, and a deicing agent.

A fourth aspect according to the present invention relates to a fuel oil composition produced by the production method. It is preferable that the fuel oil composition satisfy specification values for an aviation turbine fuel oil specified in ASTM D7566-11.

### Advantageous Effects of Invention

According to the present invention, a method for producing a fuel oil base that can produce a wax ester from a microalga Euglena with high efficiency to produce a fuel oil base suitable for an aviation fuel efficiently is provided. According to the present invention, a fuel oil base produced by the production method, a fuel oil composition containing the fuel oil base, and the method for producing the fuel oil composition are also provided.

### BRIEF DESCRIPTION OF DRAWINGS

FIG. 1 is a graph showing the results of component analysis of oils and fats in Example 1.

FIG. 2 is a graph showing the results of component analysis of oils and fats in Examples 1 to 3 and Comparative Examples 1 and 2.

### DESCRIPTION OF EMBODIMENTS

Suitable embodiments according to the present invention will be described below.

The method for producing a fuel oil base according to the present embodiment comprises a first step of aerobically culturing a microalga Euglena under a nitrogen-deficient condition; a second step of adding a nutrient to a treatment solution containing the microalga Euglena cultured in the first step, adjusting the dissolved oxygen concentration of the treatment solution to 0.03 mg/L or less, and performing anaerobic fermentation of the microalga Euglena to produce a wax ester; and a third step of hydrotreating a raw material oil containing the wax ester to produce a fuel oil base.

The microalga Euglena refers to those included in the genus: Euglena, the order: Euglenida which belongs to the plant flagellate subclass: Phytomastigophorea, the flagellate class: Mastigophorea, the phylum: Protozoa in zoology. The microalga Euglena may refer to those included in the genus: Euglena, the order: Euglenales, the class: Euglenophyceae, the division: Euglenophyta in botany.

In the present embodiment, a microalga Euglena aerobically cultured under an autotrophic culturing condition with carbon dioxide flows can be used in the first step. In other words, the production method may comprise a pre-culturing step of aerobically culturing the microalga Euglena under the autotrophic culturing condition with carbon dioxide flows, prior to the first step.

Hereinafter, the pre-culturing step and the first to third steps will be described in detail.

(Pre-Culturing Step)

The pre-culturing step is a step of aerobically culturing the microalga Euglena under an autotrophic culturing condition with carbon dioxide flows.

In the method described in Patent Literature 1, an organic substance such as glucose is added as a carbon source to perform aerobic culturing; however, such a method has little merit in cost and cannot attain fixation of carbon dioxide.

In the pre-culturing step, carbon dioxide is used as the carbon source; for this reason, the method according to the present embodiment has great merits in cost and can attain a reduction in the environmental load by fixation of carbon dioxide. Usually, the productivity when carbon dioxide is used as the carbon source tends to be inferior to that when glucose or the like is used as the carbon source; however, the production method according to the present embodiment can produce the wax ester with high efficiency through the first step and the second step; for this reason, sufficient productivity is achieved even if the pre-culturing step is used.

Examples of culturing under an autotrophic culturing condition include culturing in an autotrophic culture medium. As the autotrophic culture medium, an AY culture medium can be suitably used.

The AY culture medium is an autotrophic culture medium composed by removing heterotrophic components such as glucose, malic acid, and amino acid from a Koren-Hutner culture medium usually used as the heterotrophic culture medium for the microalga Euglena.

Examples of the AY culture medium includes an AY culture medium having the composition shown in Table 1. In Table 1, VB₁ designates vitamin B₁, and VB₂ designates vitamin B₂.

TABLE 1

| Component | g/L | Component | mg/L |
|---|---|---|---|
| (NH₄)₂SO₄ | 0.5 | FeSO₄•7H₂O | 50 |
| (NH₄)₂HPO₄ | 0.25 | MnCl₂•4H₂O | 18 |
| KH₂PO₄ | 0.25 | ZnSO₄•7H₂O | 25 |
| MgCO₃ | 0.6 | (NH₄)₆M_{O7}O₂₄•4H₂O | 4 |
| CaCO₃ | 0.12 | CuSO₄ | 1.2 |
| MgSO₄•7H₂O | 0.6 | H₃BO₃ | 0.6 |
| | | VB₁ | 2.5 |
| | | VB₂ | 0.005 |

It is preferable that the autotrophic culture medium be adjusted to an acidic condition, for example, it is preferable that the pH be adjusted to 2.5 to 6.5, and it is more preferable that the pH be adjusted to 3.0 to 6.0. The pH can be adjusted using dilute sulfuric acid, for example. It is preferable that the autotrophic culture medium be subjected to a sterilizing treatment such as autoclave sterilization.

The pre-culturing step can be performed by planting the cell strains of the microalga Euglena (such as Euglena gracilis Z strains) in the autotrophic culture medium and aerating the autotrophic culture medium with carbon dioxide, for example. More specifically, the pre-culturing step can be performed by flowing carbon dioxide in a concentration of 5 to 20% at a flow rate of 0.05 to 0.2 vvm (100 to 400 mL/min), for example. “vvm” is an abbreviation of “volume per volume per minute” representing a gas flow amount per unit volume.

In the pre-culturing step, the autotrophic culture medium may be irradiated with light; as the condition of irradiation with light, a light and dark cycle in which light is turned on for 12 hours and then turned off for 12 hours can be used to make the irradiation condition close to the outdoor condition of day and night, for example. The intensity of light to be irradiated can be 600 to 1200 mmol/(m²·s) in terms of the intensity of the light emitted onto the top surface of the autotrophic culture medium.

The culturing time in pre-culturing step may be 24 to 120 hours, and preferably 48 to 96 hours, for example.

It is preferable that the culturing temperature in the pre-culturing step be 26 to 32° C., and it is more preferable that the temperature be 28 to 30° C.

A specific aspect of the pre-culturing step will be shown below.

In this aspect, first, the AY culture medium having the composition shown in Table 1 is prepared using deionized water, the pH is adjusted to 3.5 with dilute sulfuric acid, and autoclave sterilization is performed. Next, approximately 2 L of the sterilized AY culture medium is poured to a level of 20 cm in an acrylic culturing container measuring a length of 10 cm, a width of 10 cm, and a height of 27 cm, and Euglena gracilis Z strains are planted in the medium.

Next, the culturing container is placed inside of a thermostat water bath installed on a magnetic stirrer SRSB10LA (made by ADVANTEC Co., LTD.), and the medium is stirred at a strength of 300 rpm using a 6 cm stirrer. A metal halide lamp Eye Clean Ace BT (made by Iwasaki Electric Co., Ltd.) as a light source is placed immediately above the surface of the culture solution, and its height is adjusted such that the light illuminating the surface of the culture solution has an intensity of approximately 900 μmol/(m²·s).

For the light irradiation time, the light and dark cycle in which light is turned on for 12 hours and then turned off for 12 hours is employed to make the condition close to the outdoor condition of day and night; carbon dioxide in a concentration of 15% as the carbon source is flowed at a flow rate of 0.1 vvm (200 mL/min), and culturing is performed.

After culturing for 3 days, Euglena is centrifuged from the 2 L culture solution (2500 rpm, 5 minutes, room temperature), and was washed with deionized water once to obtain the microalga Euglena subjected to the pre-culturing step.

(First Step)

The first step is a step of aerobically culturing the microalga Euglena under a nitrogen-deficient condition. The first step can increase the amount of paramylon accumulated in the microalga Euglena.

The microalga Euglena used in the first step may be the microalga Euglena cultured in the pre-culturing step, for example.

Examples of culturing under a nitrogen-deficient condition include culturing in a nitrogen-deficient culture medium. Here the nitrogen-deficient culture medium refers to a culture medium containing a nitrogen-containing compound in an amount of 5 mg/L or less. For the nitrogen-deficient culture medium, a nitrogen-deficient AY culture medium or the like can be suitably used.

Examples of the nitrogen-deficient culture medium include a nitrogen-deficient AY culture medium having a composition shown in Table 2.

TABLE 2

| Component | g/L | Component | mg/L |
|---|---|---|---|
| KH₂PO₄ | 0.25 | FeSO₄•7H₂O | 50 |
| MgCO₃ | 0.6 | MnCl₂•4H₂O | 18 |
| CaCO₃ | 0.12 | ZnSO₄•7H₂O | 25 |
| MgSO₄•7H₂O | 0.6 | (NH₄)₆M_{O7}O₂₄•4H₂O | 4 |
| | | CuSO₄ | 1.2 |
| | | H₃BO₃ | 0.6 |
| | | VB₁ | 2.5 |
| | | VB₂ | 0.005 |

It is preferable that the nitrogen-deficient culture medium be adjusted to an acidic condition, for example, it is preferable that the pH be adjusted to 2.5 to 6.5, and it is more preferable that the pH be adjusted to 3.0 to 6.0. The pH can be adjusted with dilute sulfuric acid, for example. It is preferable that the nitrogen-deficient culture medium be subjected to a sterilizing treatment such as autoclave sterilization.

The nitrogen-deficient culture medium may be irradiated with light in the first step; as the condition of irradiation with light, for example, a light and dark cycle in which light is turned on for 12 hours and then turned off for 12 hours can be used to make the irradiation condition close to the outdoor condition of day and night. The intensity of the light to be irradiated can be 600 to 1200 mmol/(m²·s) in terms of the intensity of the light emitted on the top surface of the nitrogen-deficient culture medium.

In the first step, the nitrogen-deficient culture medium may be aerated with carbon dioxide; for example, carbon dioxide in a concentration of 5 to 20% may be flowed at a flow rate of 0.05 to 0.2 vvm (100 to 400 mL/min).

It is preferable that the proportion of the microalga Euglena contained in the nitrogen-deficient culture medium be 0.05 to 5.0 g/L, and it is more preferable that the proportion be 0.2 to 1.0 g/L.

It is preferable that the culturing temperature in the first step be 26 to 32° C., and it is more preferable that the temperature be 28 to 30° C.

It is preferable that the culturing time in the first step be 24 to 72 hours, and it is more preferable that the time be 24 to 48 hours. At a culturing time of 24 hours or more, the amount of paramylon accumulated can be more significantly increased; at a culturing time of 72 hours or less, an increase in the time necessary for the first step can be suppressed.

A specific aspect of the first step will be shown below.

In this aspect, first, the nitrogen-deficient AY culture medium having the composition shown in Table 2 is prepared using deionized water, the pH is adjusted to 3.5 with dilute sulfuric acid, and autoclave sterilization is performed. Next, approximately 4.5 L of the sterilized nitrogen-deficient AY culture medium is poured to a level of 20 cm in an acrylic culturing container measuring a length of 15 cm, a width of 15 cm, and a height of 27 cm, and the microalga Euglena cultured in the pre-culturing step is planted in the medium. The initial concentration of the microalga Euglena in the nitrogen-deficient AY culture medium is 0.3 g/L.

Next, the culturing container is placed inside of a thermostat water bath installed on a magnetic stirrer SRSB10LA (made by ADVANTEC Co., LTD.), and the medium is stirred at a strength of 300 rpm using a 6 cm stirrer. A metal halide lamp Eye Clean Ace BT (made by Iwasaki Electric Co., Ltd.) is placed immediately above the surface of the culture solution, and its height is adjusted such that the light illuminating the surface of the culture solution has an intensity of approximately 900 μmol/(m²·s).

For the light irradiation time, the light and dark cycle in which light is turned on for 12 hours and then turned off for 12 hours is employed to make the condition close to the outdoor condition of day and night; carbon dioxide in a concentration of 15% as the carbon source is flowed at a flow rate of 0.1 vvm (200 mL/min), and culturing is performed.

After culturing for 48 hours, the culture solution may be fed to the second step as it is, or may be condensed with a centrifuge or the like and be fed to the second step. Here, for example, the 2 L culture solution can be condensed to approximately 0.5 L.

(Second Step)

The second step is a step of adding a nutrient to the treatment solution containing the microalga Euglena cultured in the first step, adjusting the dissolved oxygen concentration of the treatment solution to 0.03 mg/L or less, and performing the anaerobic fermentation of the microalga Euglena to produce a wax ester.

The microalga Euglena cultured in the first step is excellent in an amount of paramylon accumulated, but has a low efficiency of the wax ester production in the anaerobic fermentation. The second step can improve the efficiency of the wax ester production of the microalga Euglena in the anaerobic fermentation and then produce the wax ester by the anaerobic fermentation.

The anaerobic fermentation is performed by keeping the microalga Euglena under an anaerobic condition. Here the anaerobic condition means that the dissolved oxygen concentration of the treatment solution containing the microalga Euglena is 0.03 mg/L or less.

In the second step, it is preferable that the nutrient be added to the treatment solution 3 hours before the dissolved oxygen concentration of the treatment solution is adjusted to 0.03 mg/L or less, and it is more preferable that the nutrient be added to the treatment solution 1 hour before the dissolved oxygen concentration of the treatment solution is adjusted to 0.03 mg/L or less. In other words, it is preferable that in the second step, the dissolved oxygen concentration of the treatment solution is adjusted to 0.03 mg/L or less within 3 hours (more preferably within 1 hour) after the nutrient is added to the treatment solution.

The nutrient may be a nitrogen source, a carbon source, or a mixture of a nitrogen source and a carbon source.

Examples of the nitrogen source include ammonium compounds such as diammonium hydrogenphosphate and ammonium sulfate; and amino acids such as glycine and glutamic acid; among these, ammonium compounds are preferable.

Examples of the carbon source include saccharides such as glucose and fructose; alcohols such as ethanol; organic substances such as malic acid; and amino acids such as glutamic acid; among these, saccharides are preferable, and glucose is more preferable.

It is preferable that the amount of the nitrogen source to be added as the nutrient be 7 to 15 mg/L of the treatment solution in terms of the mass of ammonium ion where nitrogen atoms contained in the nitrogen source are converted into ammonium ions, and it is more preferable that the amount be 8 to 12 mg/L of the treatment solution in terms of the mass of ammonium ion where nitrogen atoms contained in the nitrogen source are converted into ammonium ions.

It is preferable that the amount of the carbon source to be added as the nutrient be 0.2 to 2.0 g/L of the treatment solution, and it is more preferable that the amount be 0.5 to 1.5 g/L of the treatment solution.

Usually Euglena cannot assimilate nitrate nitrogen; if Euglena is modified by gene recombination techniques or the like to assimilate nitric acid, it is thought that nitrate nitrogen absorbed from an outside of the cells is metabolized into ammoniacal nitrogen; in this case, the nitrogen source includes nitric acid compounds.

The anaerobic fermentation can be performed, for example, by flowing an inert gas such as nitrogen gas and argon gas into the treatment solution to reduce the dissolved oxygen concentration of the treatment solution to 0.03 mg/L or less. The anaerobic fermentation can be also performed by reducing the dissolved oxygen concentration of the treatment solution by, for example, condensing the treatment solution to increase the density of cells.

It is preferable that the fermentation temperature in the anaerobic fermentation be 20 to 30° C., and it is more preferable that the temperature be 25 to 28° C.

The fermentation time in the anaerobic fermentation may be 24 to 120 hours, and preferably 48 to 96 hours.

In the anaerobic fermentation, irradiation with light is not always necessary. Adjustment of the pH of the treatment solution is not always necessary, and the pH can be in the range of 3 to 7, for example.

At least part of the paramylon accumulated in the microalga Euglena is converted into the wax ester by the anaerobic fermentation. The wax ester can be extracted from the microalga Euglena by a known method after the anaerobic fermentation. Specifically, for example, the microalga Euglena is recovered by centrifugation or the like, and is freeze dried to form dry powder; the wax ester can be extracted from the dry powder with an organic solvent.

Here in the anaerobic fermentation, diglyceride and triglyceride may be generated in addition to the wax ester. In this case, mixed oils and fats containing the wax ester, diglyceride, and triglyceride can be obtained by the extraction operation. The mixed oils and fats may be used as they are as the raw material oil in the third step, or wax ester may be further separated from the mixed oils and fats and be fed to the third step.

A specific aspect of the second step will be shown below. In this aspect, first, 0.164 g (equivalent to 10 mg/L) of ((NH₄)₂HPO₄) as the nitrogen source per 1 L culture solution is added to the culture solution produced in the first step. Depending on the case, 1 g of glucose as the carbon source per 1 L culture solution is added instead of or in addition to the nitrogen source.

The culture solution is condensed to approximately ¼ in terms of the volume ratio with a centrifuge, and 400 mL of the condensed solution is placed in a tall beaker having a volume of 600 mL. Next, nitrogen gas is flowed at a flow rate of 200 mL/min for approximately 30 minutes to reduce the dissolved oxygen concentration of the condensed solution to 0.03 mg/L or less. Preferably, the dissolved oxygen concentration is reduced to 0.01 mg/L or less.

After nitrogen gas is flowed, the top of the flask is covered with a Parafilm, and the entire flask is covered with an aluminum foil to be shielded against light; the flask is left to stand at room temperature (26 to 27° C. for 3 days to perform anaerobic fermentation. After the anaerobic fermentation, the wax ester can be recovered by a known method.

(Third Step)

The third step is a step of hydrotreating a raw material oil containing the wax ester produced in the second step to produce a fuel oil base.

It is only necessary for the raw material oil to contain the wax ester produced in the second step, and the raw material oil may contain, for example, diglyceride and triglyceride formed in the second step in addition to the wax ester.

In the third step, the hydrotreating conditions and the like can be properly varied according to the characteristics of the raw material oil and those of the target fuel oil base. For example, in the third step, the raw material oil can be subjected to the hydrorefining treatment and the hydroisomerization treatment as hydrotreating.

Hereinafter, an aspect of the hydrorefining treatment and hydroisomerization treatment particularly suitable for production of the fuel oil base for an aviation fuel from the raw material oil containing the wax ester produced through the first step and the second step will be shown.

(Hydrorefining Treatment)

The raw material oil fed to the hydrorefining treatment contains the wax ester produced through the first step and the second step, and may further contain a sulfur-containing compound depending on cases. The raw material oil to which the sulfur-containing compound is added can improve the catalyst activity (deoxidation activity) of the catalyst for the hydrorefining treatment described later.

Examples of the sulfur-containing compound include sulfide, disulfide, polysulfide, thiol, thiophene, benzothiophene, dibenzothiophene, derivatives thereof, and hydrogen sulfide. The sulfur-containing compound added to the raw material oil may be one or two or more.

The raw material oil may contain the wax ester produced through the first step and the second step and a petroleum hydrocarbon fraction containing a sulfur content, for example. For the petroleum hydrocarbon fraction containing a sulfur content, fractions produced by a typical petroleum refining step can be used.

Examples of the petroleum hydrocarbon fractions include fractions produced with atmospheric distillation units, vacuum distillation units, and the like and having a boiling point in a predetermined range; and fractions produced with hydrodesulphurization units, hydrocrackers, residual oil direct desulphurization units, fluidized bed catalytic cracking units, and the like and having a boiling point in a predetermined range. The fractions produced with the respective apparatuses may be used alone or in combination by mixing.

It is preferable that the content of the sulfur-containing compound in the raw material oil (sulfur content in the raw material oil) be 1 to 50 mass ppm based on the total amount of the raw material oil in terms of the sulfur atom, it is more preferable that the content be 5 to 30 mass ppm, and it is still more preferable that the content be 10 to 20 mass ppm. At a content of 1 mass ppm or more, the effect of improving the catalyst activity (deoxidation activity) of the catalyst for the hydrorefining treatment can be remarkably attained. At a content of 50 mass ppm or less, an excessive increase in the concentration of sulfur in the gas discharged in the hydrorefining treatment (light gas) and the concentration of sulfur in the hydrocarbon oil after the hydrorefining treatment can be suppressed.

The content of the sulfur-containing compound in the raw material oil refers to the mass content of the sulfur content measured according to JIS K 2541 “Sulfur content test method” or a method described in ASTM D 5453.

The sulfur-containing compound may be added to the raw material oil before a recycled oil described later is blended with the raw material oil, but it is preferable that the sulfur-containing compound be added to the raw material oil after the recycled oil is blended with the raw material oil and before the raw material oil is fed to the hydrorefining treatment. This method can more securely control the amount of the sulfur content in the raw material oil to be fed to the hydrorefining treatment. In the present embodiment, the sulfur-containing compound may be added to the raw material oil in advance, and the raw material oil may be introduced into a reactor of a hydrorefining treatment unit; or the sulfur-containing compound may be fed at a previous stage of the reactor when the raw material oil is introduced into the reactor of the hydrorefining treatment unit.

For the conditions for the hydrorefining treatment, the conditions of a hydrogen pressure of 2 to 13 MPa, a liquid hourly space velocity of 0.1 to 3.0 h⁻¹, a hydrogen/oil ratio of 150 to 1500 NL/L, and a reaction temperature of 150 to 480° C. are preferable; the conditions of a hydrogen pressure of 2 to 13 MPa, a liquid hourly space velocity of 0.1 to 3.0 h⁻¹, a hydrogen/oil ratio of 150 to 1500 NL/L, and a reaction temperature of 200 to 400° C. are more preferable; and the conditions of a hydrogen pressure of 3 to 10.5 MPa, a liquid hourly space velocity of 0.25 to 1.0 h⁻¹, a hydrogen/oil ratio of 300 to 1000 NL/L, and a reaction temperature of 260 to 360° C. are still more preferable.

As the catalyst used in the hydrorefining treatment, a catalyst having a carrier comprising a porous inorganic oxide containing two or more elements selected from aluminum, silicon, zirconium, boron, titanium and magnesium, and a metal selected from elements in Groups 6 and 8 in the periodic table and carried on the carrier is suitably used.

For the carrier of the catalyst used in the hydrorefining treatment, a porous inorganic oxide comprising two or more elements selected from aluminum, silicon, zirconium, boron, titanium, and magnesium is suitably used. Usually the carrier is a porous inorganic oxide comprising alumina, and examples of other carrier-forming components include silica, zirconia, boria, titania, and magnesia. Desirably, the carrier is a composite oxide comprising alumina and at least one other forming components, and examples include silica-alumina. The carrier may contain phosphorus as an additional component. It is preferable that the total content of the components other than alumina be 1 to 20% by weight, and it is more desirable that the total content be 2 to 15% by weight. At a total content of the components other than alumina less than 1% by weight, a sufficient catalyst surface area cannot be attained, and its activity may be reduced; at a content more than 20% by weight, the acidic substance in the carrier is increased, and the activity may be reduced by generation of coke. If phosphorus is contained as a carrier forming component, it is desirable that the content be 1 to 5% by weight in terms of oxide, and it is more desirable that the content be 2 to 3.5% by weight.

Raw materials for precursors of silica, zirconia, boria, titania, and magnesia, which are the carrier forming components other than alumina, are not particularly limited, and a typical solution containing silicon, zirconium, boron, titanium, or magnesium can be used. For example, silicic acid, water glass, silica sol, and the like can be used as silicon; titanium sulfate, titanium tetrachloride, a variety of alkoxide salts, and the like can be used as titanium; zirconium sulfate, a variety of alkoxide salts, and the like can be used as zirconium; boric acid and the like can be used as boron. Magnesium nitrate and the like can be used as magnesium. Phosphoric acid, alkali metal salts of phosphoric acid, or the like can be used as phosphorus.

It is desirable that the raw materials for the carrier forming components other than alumina be added in any one of the steps before calcination of the carrier. For example, the raw material may be added to an aluminum aqueous solution in advance to prepare an aluminum hydroxide gel containing these carrier forming components; the raw material may be added to a prepared aluminum hydroxide gel; or the raw material may be added in a step of adding water or an acidic aqueous solution to a commercially available alumina intermediate product or boehmite powder and kneading these; a method for coexistence of these in preparation of the aluminum hydroxide gel is more desirable. Although the mechanism to demonstrate the effect of these carrier forming components other than alumina is not clarified, it seems that the carrier forming component forms an aluminum composite-like oxide state, and this may cause an increase in the carrier surface area or an interaction with an active metal to influence the activity.

The active metal of the catalyst in the hydrorefining treatment contains preferably at least one metal selected from metals in Groups 6 and 8 in the periodic table, and more preferably two or more metals selected from Groups 6 and 8. A hydrotreating catalyst containing at least one metal selected from Group 6 and at least one metal selected from Group 8 as the active metals is also suitable. Examples of a combination of the active metals include Co—Mo, Ni—Mo, Ni—Co—Mo, and Ni—W, and these metals are converted into sulfides and used in hydrotreating.

The content of the active metal, for example, the total amount of W and Mo carried is desirably 12 to 35% by weight, and more desirably 15 to 30% by weight based on the weight of the catalyst in terms of oxide. At a total amount of W and Mo carried of less than 12% by weight, a reduction in the number of active sites may reduce the activity; at a total amount more than 35% by weight, the metals may not be effectively dispersed, also reducing the activity. The total amount of Co and Ni carried is desirably 1.5 to 10% by weight, and more desirably 2 to 8% by weight based on the weight of the catalyst in terms of oxide. At a total amount of Co and Ni carried of less than 1.5% by weight, a sufficient cocatalyst effect may not be attained, reducing the activity; at a total amount more than 10% by weight, the metals may not be effectively dispersed, also reducing the activity.

In any one of the above catalysts, a method for carrying the active metal on the carrier is not particularly limited, and a known method usually used in production of a desulphurization catalyst or the like can be used. Usually a method for impregnating the carrier of the catalyst with a solution containing an active metal salt is preferably used. An equilibrium adsorption method, a Pore-filling method, an Incipient-wetness method, and the like are preferably used. For example, the Pore-filling method is a method comprising measuring the pore volume of the carrier in advance and impregnating the carrier with a metal salt solution having the same volume as that; the impregnation method is not particularly limited, and the carrier can be impregnated by a proper method depending on the amount of the metal carried and the physical properties of the carrier of the catalyst.

The reactor used in the hydrorefining treatment may be of a fixed bed type. Namely, hydrogen may flow for or against the raw material oil; or the reactor may have a plurality of reaction towers to flow hydrogen for and against of the flow of the raw material oil in combination. A typical one is a down flow type, which can use a gas-liquid parallel flow method. The reactors may be used alone or in combination, or a structure in which the inside of a reactor is divided into a plurality of catalyst beds may be used. The hydrorefined oil subjected to the hydrorefining treatment in the reactor can be fractionated into a predetermined fraction through a gas liquid separation step, a refining step, and the like. At this time, to remove water and by-produced gases such as carbon monoxide, carbon dioxide, and hydrogen sulfide generated through the reaction, a gas liquid separating facility or another by-produced gas removing apparatus may be provided between reactors or may be used in a product recovering step. Examples of the apparatus for removing byproducts preferably include a high pressure separator.

Usually the hydrogen gas is introduced from an inlet of a first reactor with the raw material oil before or after the raw material oil passes through a heating furnace; separately from this, the hydrogen gas may be introduced between the catalyst beds or the reactors to control the temperature inside of the reactor and keep the hydrogen pressure across the inner reactor. The hydrogen thus introduced is referred to as quenched hydrogen. At this time, the proportion of the quenched hydrogen to the hydrogen introduced with the raw material oil is desirably 10 to 60% by volume, and more desirably 15 to 50% by volume in the standard state (0° C., 1 atm). At a proportion of the quenched hydrogen less than 10% by volume, the reaction in the rear stage reaction site may not sufficiently progress; at a proportion more than 60% by volume, the reaction near the inlet of the reactor may not sufficiently progress.

In the present embodiment, in the hydrorefining treatment of the raw material oil, a specific amount of a recycled oil may be contained in the raw material oil to suppress the amount of heat generated in the hydrorefining reactor. It is preferable that the content of the recycled oil be 0.5 to 5 times the mass of the oils and fats derived from the microalga Euglena (total amount of the wax ester, diglyceride, and triglyceride), and the ratio can be properly determined within the range thereof according to the highest use temperature of the hydrorefining reactor. This is because assuming that these both have the same specific heat, if these are mixed at 1:1, an increase in the temperature is half an increase in the temperature when the oils and fats derived from the microalga Euglena are reacted alone; for this reason, at a ratio within the above range, reaction heat can be sufficiently reduced. At a content of the recycled oil more than 5 times the mass of the oils and fats derived from the microalga Euglena, the concentration of the oils and fats reduces to reduce reactivity and the flow rate in a piping or the like increases to increase load. At a content of the recycled oil less than 0.5 times the mass of the oils and fats derived from the microalga Euglena, an increase in temperature cannot be sufficiently suppressed.

A method for mixing the raw material oil with the recycled oil is not particularly limited; for example, these may be premixed, and the pre-mixture may be introduced into the reactor of the hydrorefining unit, or the recycled oil may be fed in a front stage of the reactor for introduction of the raw material oil into the reactor. Furthermore, reactors can be connected to each other in series, and the mixture can be introduced between the reactors; or a catalyst layer can be divided within a single reactor, and the mixture can be introduced between the divided catalyst layers.

It is preferable that the recycled oil contain part of a hydrorefined oil produced by removing by-produced water, carbon monoxide, carbon dioxide, hydrogen sulfide, and the like after the raw material oil is hydrorefined. Furthermore, it is preferable that the recycled oil contain part of a light fraction, an intermediate fraction, or a heavy fraction fractionated from the hydrorefined oil and isomerized or part of an intermediate fraction fractionated from the hydrorefined oil further isomerized.

(Hydroisomerization Treatment)

In this aspect, the hydrorefined oil produced through the hydrorefining treatment may be subjected to a hydroisomerization treatment. By performing the hydroisomerization treatment, the proportion of isoparaffin contained in the fuel oil base can be increased to improve low temperature performance.

It is preferable that the content of the sulfur content contained in the hydrorefined oil, which is the raw material oil used in the hydroisomerization treatment, be 1 mass ppm or less, and it is more preferable that the content be 0.5 mass ppm. At a content of the sulfur content more than 1 mass ppm, progression of the hydroisomerization may be prevented. In addition, for the same reason, the sulfur content needs to be sufficiently low in the reaction gas containing the hydrogen introduced with the hydrogenated oil, it is preferable that the concentration be 1 volume ppm or less, and it is more preferable that the concentration be 0.5 volume ppm or less.

It is desirable that the hydroisomerization treatment be performed in the presence of hydrogen under the conditions of a hydrogen pressure of 1 to 5 MPa, a liquid hourly space velocity of 0.1 to 3.0 h⁻¹, a hydrogen/oil ratio of 250 to 1500 NL/L, and a reaction temperature of 200 to 360° C., it is more desirable that the hydroisomerization treatment be performed under the conditions of a hydrogen pressure of 0.3 to 4.5 MPa, a liquid hourly space velocity of 0.5 to 2.0 h⁻¹, a hydrogen/oil ratio of 380 to 1200 NL/L, and a reaction temperature of 220 to 350° C., and it is still more desirable that the hydroisomerization treatment be performed under the conditions of a hydrogen pressure of 0.5 to 4.0 MPa, a liquid hourly space velocity of 0.8 to 1.8 h⁻¹, a hydrogen/oil ratio of 350 to 1000 NL/L, and a reaction temperature of 250 to 340° C.

For the catalyst used in the hydroisomerization treatment, a catalyst comprising a carrier comprising a porous inorganic oxide composed of a substance selected from aluminum, silicon, zirconium, boron, titanium, magnesium and zeolite, and at least one metal selected form elements in Group 8 in the periodic table and carried on the carrier is suitably used.

Examples of the porous inorganic oxide used as the carrier of the hydroisomerization treatment catalyst include alumina, titania, zirconia, boria, silica, or zeolite; in this aspect, among these, porous inorganic oxides composed of at least one selected form titania, zirconia, boria, silica, and zeolite and alumina are preferable. The production method is not particularly limited; any preparation method can be used using a raw material corresponding to each element in a state of a variety of sols, salt compounds, or the like. Furthermore, a composite hydroxide or composite oxide such as silica alumina, silica zirconia, alumina titania, silica titania, and alumina boria may be prepared once, and an alumina gel thereof, a hydroxide thereof, or a proper solution thereof may be added at any step of the preparation process to prepare the porous inorganic oxide. Alumina and the other oxide can be contained in any proportion to the carrier; the proportion of alumina is preferably 90% by mass or less, more preferably 60% by mass or less, more preferably 40% by mass or less, preferably 10% by mass or more, and more preferably 20% by mass or more.

Zeolite is crystalline aluminosilicate, and examples thereof include faujasite, pentasil, mordenite, TON, MTT, and *MRE; those ultrastabilized by a predetermined hydrothermal treatment and/or an acid treatment or those having an adjusted content of alumina in zeolite can be used. Preferably faujasite and mordenite, particularly preferably a Y type and a beta type are used. For the Y type, those ultrastabilized are preferable; zeolite ultrastabilized by the hydrothermal treatment has an original pore structure called micropore of 20 angstroms or less, and in addition to this, new pores in the range of 20 to 100 angstroms are formed. For the hydrothermal treatment conditions, known conditions can be used.

For the active metal used in the catalyst for the hydroisomerization treatment, at least one metal selected from elements in Group 8 in the periodic table is used. Among these metals, it is preferable that at least one metal selected form Pd, Pt, Rh, Ir, Au, and Ni be used, and it is more preferable that these be used in combination. Examples of a suitable combination include Pd—Pt, Pd—Ir, Pd—Rh, Pd—Au, Pd—Ni, Pt—Rh, Pt—Ir, Pt—Au, Pt—Ni, Rh—Ir, Rh—Au, Rh—Ni, Ir—Au, Ir—Ni, Au—Ni, Pd—Pt—Rh, Pd—Pt—Ir, and Pt—Pd—Ni. Among these, combinations of Pd—Pt, Pd—Ni, Pt—Ni, Pd—Ir, Pt—Rh, Pt—Ir, Rh—Ir, Pd—Pt—Rh, Pd—Pt—Ni, and Pd—Pt—Ir are more preferable, and combinations of Pd—Pt, Pd—Ni, Pt—Ni, Pd—Ir, Pt—Ir, Pd—Pt—Ni, and Pd—Pt—Ir are still more preferable.

It is preferable that the total content of the active metals be 0.1 to 2% by mass based on the mass of the catalyst in terms of the metal, it is more preferable that the total content of the active metals be 0.2 to 1.5% by mass based on the mass of the catalyst, it is still more preferable that the total content of the active metals be 0.5 to 1.3% by mass based on the mass of the catalyst. At a total amount of the metals carried less than 0.1% by mass, the active sites are reduced, and sufficient activity tends not to be attained. At a total amount more than 2% by mass, the metals are not effectively dispersed, and sufficient activity tends not to be attained.

In any one of the catalysts used in the hydroisomerization treatment, the method for carrying the active metal on the carrier is not particularly limited, a known method usually used in production of a desulphurization catalyst can be used. Usually, a method comprising impregnating a carrier of a catalyst with a solution containing an active metal salt is preferably used. An equilibrium adsorption method, a Pore-filling method, an Incipient-wetness method, and the like are also preferably used. For example, the Pore-filling method is a method in which the pore volume of the carrier is measured in advance, and the carrier is impregnated with a metal salt solution having the same volume as that; the impregnation method is not particularly limited, and the carrier can be impregnated by a proper method depending on the amount of the metal to be carried and the physical properties of the carrier of the catalyst.

It is preferable that before the isomerization treatment catalyst used in this aspect is fed to the reaction, the active metal contained in the catalyst be reduced. The reduction conditions are not particularly limited, and the active metal is reduced by a treatment under a hydrogen stream at a temperature of 200 to 400° C. It is preferable that the treatment is performed preferably in the range of 240 to 380° C. At a reduction temperature less than 200° C., the reduction of the active metal does not sufficiently progress, and hydrodeoxidation and hydroisomerization activity may not be exhibited. At a reduction temperature more than 400° C., aggregation of the active metal progresses, and the activity may also not be exhibited.

The reactor used in the hydroisomerization treatment may be of a fixed bed type. Namely, hydrogen may flow for or against the raw material oil; or the reactor may have a plurality of reaction towers to flow hydrogen for and against of the flow of the raw material oil in combination. A typical one is a down flow type, which can use a gas-liquid parallel flow method. The reactors may be used alone or in combination, or a structure in which the inside of a reactor is divided into a plurality of catalyst beds may be used.

Usually the hydrogen gas is introduced from an inlet of a first reactor with the raw material oil before or after the raw material oil passes through a heating furnace; separately from this, the hydrogen gas may be introduced between the catalyst beds or the reactors to control the temperature inside of the reactor and keep the hydrogen pressure across the inner reactor. The hydrogen thus introduced is referred to as quenched hydrogen. At this time, the proportion of the quenched hydrogen to the hydrogen introduced with the raw material oil is desirably 10 to 60% by volume, and more desirably 15 to 50% by volume in the standard state (0° C., 1 atm). At a proportion of the quenched hydrogen less than 10% by volume, the reaction in the rear stage reaction site may not sufficiently progress; at a proportion more than 60% by volume, the reaction near the inlet of the reactor may not sufficiently progress.

The hydroisomerized oil produced after the hydroisomerization treatment step may be fractionated into several fractions with a rectifying column when necessary. For example, the hydroisomerized oil may be fractionated into gas, a light fraction such as naphtha fraction, an intermediate fraction such as kerosene, jet fuels, and a gas oil fraction, and a heavy fraction such as residues. In this case, it is preferable that the cut temperature of the light fraction and the intermediate fraction be 100 to 200° C., it is more preferable that the cut temperature be 120 to 180° C., it is still more preferable that the cut temperature be 120 to 160° C., and it is further still more preferable that the cut temperature be 130 to 150° C. It is preferable that the cut temperature of the intermediate fraction and the heavy fraction be 250 to 360° C., it is more preferable that the cut temperature be 250 to 320° C., it is still more preferable that the cut temperature be 250 to 300° C., and it is further still more preferable that the cut temperature be 250 to 280° C. By reforming part of such a light hydrocarbon fraction to be generated in a steam reforming apparatus, hydrogen can be produced. The hydrogen thus produced has carbon neutrality because the raw material used in the steam reforming is the hydrocarbon derived from a biomass, and can reduce the load on the environment. The intermediate fraction produced by fractionating the hydroisomerized oil can be suitably used as the fuel oil base for an aviation fuel.

(Fuel Oil Base)

The fuel oil base according to the present embodiment is a fuel oil base produced by the production method. Hereinafter, one aspect of a fuel oil base suitable for the fuel oil base for an aviation fuel (hereinafter referred to as an “aviation fuel oil base”) will be described in detail.

It is preferable that the aviation fuel oil base satisfy the characteristics of the base oil specified in “A2. Synthesized Paraffinic Kerosine From Hydroprocessed Esters and Fatty Acids” of ASTM D7566-11 “Standard Specification for Aviation Turbine Fuel Containing Synthesized Hydrocarbons,” and it is more preferable that suitable ranges in the following conditions (1) to (22) be satisfied.

(1) boiling point range: 140 to 300° C.,
(2) distillation temperature at 10% distillation (T10): 205° C. or less,
(3) distillation end point (FEP): 300° C. or less,
(4) difference between distillation temperature at 90% distillation (T90) and distillation temperature at 10% distillation (T10): 22° C. or more,
(5) total acid value: 0.015 mgKOH/g or less,
(6) flash point: 38° C. or more,
(7) density at 15° C.: 730 kg/in³ or more and 770 kg/m³ or less,
(8) freezing point: −45° C. or less,
(9) existing gum content: 7 mg/100 mL or less,
(10) thermal stability—pressure difference: 3.3 kPa or less,
(11) thermal stability—tube accumulation degree: less than 3,
(12) isoparaffin content: 80% by mass or more (more preferably 85% by mass or more),
(13) isoparaffin content having two or more branchings: 17% by mass or more (more preferably 20% by mass or more),
(14) aromatic content: 0.1% by mass or less,
(15) cycloparaffin content: 15% by mass or less,
(16) olefin content: less than 0.1% by mass,
(17) sulfur content: less than 1 mass ppm,
(18) oxygen content: less than 0.1% by mass,
(10) nitrogen content: 2 mass ppm or less,
(20) moisture content: 75 mass ppm or less,
(21) chlorine content: 1 mass ppm or less,
(22) metal content (Al, Ca, Co, Cr, Cu, Fe, K, Mg, Mn, Na, Ni, P, Pb, Pd, Pt, Sn, Sr, Ti, V, Zn): each 0.1 mass ppm or less.

(Boiling Point Range)

It is preferable that the boiling point of the aviation fuel oil base be in the range of 140 to 300° C. At a boiling point in the range of 140 to 300° C., the combustibility as the aviation fuel oil can be more securely satisfied. It is preferable that for the distillation characteristics of the aviation fuel oil base, T10 be 205° C. or less, and it is more preferable that T10 be 200° C. or less from the viewpoint of evaporation properties. It is preferable that FEP be 300° C. or less, it is more preferable that FEP be 290° C. or less, and it is still more preferable that FEP be 280° C. or less from the viewpoint of combustion characteristics (burnout properties). The difference between T90 and T10 (T90−T10) is 22° C. or more, and it is more preferable that it be 30° C. or more from the viewpoint of ensuring combustibility under various weather conditions. The distillation characteristics here mean the value measured according to HS K2254 “Petroleum products-distillation test method.”

(Total Acid Value)

It is preferable that the total acid value of the aviation fuel oil base be 0.015 mgKOH/g or less, it is more preferable that the total acid value be 0.01 mgKOH/g or less, it is still more preferable that the total acid value be 0.008 mgKOH/g or less, and it is further still more preferable that the total acid value be 0.005 mgKOH/g or less from the viewpoint of corrosiveness. The total acid value here means the value measured according to JIS K2276 “Total acid value test method.”

(Flash Point)

It is preferable that the flash point of the aviation fuel oil base be 38° C. or more, it is more preferable that the flash point be 40° C. or more, and it is still more preferable that the flash point be 45° C. or more from the viewpoint of safety. The flash point here means the value measured according to JIS K2265 “Crude oil and petroleum products-flash point test method-tag sealed flash point test method.”

(Density)

It is preferable that the density at 15° C. of the aviation fuel oil base be 730 kg/m³ or more, and it is more preferable that the density be 735 kg/m³ or more from the viewpoint of a fuel consumption rate. It is preferable that the density be 770 kg/m³ or less, and it is more preferable that the density be 765 kg/m³ or less from the viewpoint of combustibility. The density at 15° C. here means the value measured according to JIS K2249 “Crude oil and petroleum products-density test method and density·mass·volume conversion table.”

(Freezing Point)

It is preferable that the freezing point of the aviation fuel oil base be −45° C. or less, it is more preferable that the freezing point be −48° C. or less, and it is still more preferable that the freezing point be −50° C. or less from the viewpoint of preventing a reduction in feed of the fuel due to freezing of the fuel exposed to low temperatures during flying. The freezing point here means the value measured according to JIS K2276 “Freezing point test method.”

(Existing Gum Content)

It is preferable that the existing gum content of the aviation fuel oil base be 7 mg/100 mL or less, it is more preferable that the existing gum content be 5 mg/100 mL or less, and it is still more preferable that the existing gum content be 3 mg/100 mL or less from the viewpoint of preventing deficits due to generation of precipitates in a fuel introduction system or the like. The existing gum content here means the value measured according to HS K2261 “Gasoline and aviation fuel oil existing gum test method.”

(Thermal Stability)

It is preferable that as the thermal stability of the aviation fuel oil base (at 325° C. for 2.5 hours), a pressure difference be 3.3 kPa or less, and a tube accumulation evaluation value (tube accumulation degree) be less than 3 from the viewpoint of, for example, preventing clogging of the fuel filter due to generation of precipitates during exposure to high temperatures. The pressure difference and the tube accumulation degree as the thermal stability here mean the values measured according to ASTM D3241 “Standard Test Method for Thermal Oxidation Stability of Aviation Turbine Fuels,” respectively.

(Isoparaffin Content and 2-Branched Isoparaffin Content)

It is preferable that the content of isoparaffin in the aviation fuel oil base be 80% by mass or more, and 85% by mass or more is more preferable to satisfy the specification of low temperature performance as the aviation fuel oil. It is preferable that the content of isoparaffin having two or more branchings be 17% by mass or more, and 20% by mass or more is more preferable to satisfy the specification of low temperature performance as the aviation fuel oil. The content of isoparaffin and the content of isoparaffin having two or more branchings here mean the values measured with a gas chromatograph and a time of flight mass spectrometer (GC-TOF/MS), respectively.

(Aromatic Content and Cycloparaffin Content)

It is preferable that the aromatic content in the aviation fuel oil base be 0.1% by mass or less from the viewpoint of combustibility (prevention of generation of soot). It is preferable that the cycloparaffin content be 15% by mass or less, it is more preferable that the cycloparaffin content be 12% by mass or less, and it is still more preferable that the cycloparaffin content be 10% by mass or less from the viewpoint of ensuring combustibility. The aromatic content and cycloparaffin content here mean the values measured according to ASTM D2425 “Standard Test Method for Hydrocarbon Types in Middle Distillates by Mass Spectrometry.”

(Olefin Content)

It is preferable that the olefin content in the aviation fuel oil base be 0.1% by mass or less to prevent a reduction in oxidation stability. The olefin content here means the value measured according to ASTM D2425 “Standard Test Method for Hydrocarbon Types in Middle Distillates by Mass Spectrometry.”

(Sulfur Content)

It is preferable that the sulfur content in the aviation fuel oil base be 1 mass ppm or less, it is more preferable that the sulfur content be 0.8 mass ppm or less, and it is still more preferable that the sulfur content be 0.6 mass ppm or less from the viewpoint of prevention of corrosiveness. The sulfur content here means the value measured according to HS K2541 “Crude oil and petroleum product sulfur content test method.”

(Oxygen Content)

It is preferable that the oxygen content in the aviation fuel oil base be 0.1% by mass or less from the viewpoint of preventing a reduction in the amount of heat generated. The oxygen content here means the oxygen content measured according to UOP 649-74 “Total Oxygen in Organic Materials by Pyrolysis-Gas Chromatographic Technique.”

(Nitrogen Content)

It is preferable that the nitrogen content in the aviation fuel oil base be 2 mass ppm or less, and it is more preferable that the nitrogen content be 1.5 mass ppm or less from the viewpoint of preventing corrosion. The nitrogen content here means the value measured according to ASTM D4629 “Standard Test Method for Trace Nitrogen in Liquid Petroleum Hydrocarbons by Syringe/Inlet Oxidative Combustion and Chemiluminescence Detection.”

(Moisture Content)

It is preferable that the moisture content in the aviation fuel oil base be 75 mass ppm or less, and it is more preferable that the moisture content be 50 mass ppm or less from the viewpoint of deicing. The moisture content here means the value measured according to ASTM D6304 “Standard Test Method for Determination of Water in Petroleum Products, Lubricating Oils, and Additives by Coulometric Karl Fischer Titration.”

(Chlorine Content)

It is preferable that the chlorine content in the aviation fuel oil base be 1 mass ppm or less, and it is more preferable that the chlorine content be 0.5 mass ppm or less from the viewpoint of preventing corrosion. The chlorine content here means the value measured according to ASTM D7359 “Standard Test Method for Total Fluorine, Chlorine and Sulfur in Aromatic Hydrocarbons and Their Mixtures by Oxidative Pyrohydrolytic Combustion followed by Ion Chromatography Detection (Combustion Ion Chromatography-CIC).”

(Metal Content)

It is preferable that the metal contents in the aviation fuel oil base (Al, Ca, Co, Cr, Cu, Fe, K, Mg, Mn, Na, Ni, P, Pb, Pd, Pt, Sn, Sr, Ti, V, Zn) each be 0.1 mass ppm or less from the viewpoint of suppressing accumulated products within the engine and preventing wear. The metal content here means the value measured according to UOP 389 “Trace Metals in Organics by Wet Ash-ICP-AES,”

(Aviation Fuel Oil Composition)

The fuel oil composition according to the present embodiment (hereinafter also referred to as an “aviation fuel oil composition”) contains the aviation fuel oil base, and has a sulfur content of 10 mass ppm or less and a freezing point of −47° C. or less. In the present embodiment, the aviation fuel oil base can be mixed with a hydrorefined oil refined from a crude oil or the like (also referred to as a “petroleum base oil”) to produce an aviation fuel oil composition satisfying predetermined performance. The content of the aviation fuel oil base to the aviation fuel oil composition is not particularly limited, and it is preferable that the content be 1% by volume or more, it is more preferable that the content be 3% by volume or more, and it is still more preferable that the content be 5% by volume or more from the viewpoint of reducing the environmental load. It is preferable that the content be 50% by volume or less from the viewpoint of capable of easily producing a predetermined aviation fuel oil composition specified in ASTM D7566-11.

Examples of the petroleum base oil produced by refining a crude oil or the like include fractions produced by atmospheric distillation or vacuum distillation of a crude oil, and fractions produced by a reaction such as hydrodesulphurization, hydrocracking, fluidized catalytic cracking, and catalytic reforming. Furthermore, the petroleum base oil produced by refining a crude oil or the like may be a compound derived from a chemical or a synthetic oil produced through a Fischer-Tropsch reaction. It is preferable that the synthetic oil produced through the Fischer-Tropsch reaction satisfy the characteristics of the base oil specified in “A1. Fischer-Tropsch Hydroprocessed Synthesized Paraffinic Kerosine” of ASTM D7566-11 “Standard Specification for Aviation Turbine Fuel Containing Synthesized Hydrocarbons.” It is preferable that the lower limit of the content of the petroleum base oil produced by refining a crude oil or the like to the aviation fuel oil composition be 50% by volume or more and the upper limit be 99% by volume or less, it is more preferable that the upper limit be 97% by volume or less, and it is still more preferable that the upper limit be 95% by volume or less.

In the aviation fuel oil composition, a variety of additives used for the aviation fuel oil in the related art can be used. Examples of the additives include one or more additives selected from an antioxidant, an antistatic agent, a metal deactivator, and a deicing agent.

To suppress generation of the gum in the aviation fuel oil composition, as the antioxidant, a mixture of 75% or more of N,N-diisopropylparaphenylenediamine, 2,6-ditertiary butyl phenol, 2,6-ditertiary butyl-4-methylphenol, 2,4-dimethyl-6-tertiary-butylphenol, and 2,6-ditertiary-butylphenol and 25% or less of tertiary- and tritertiary-butylphenols, a mixture of 72% or more of 2,4-dimethyl-6-tertiary-butylphenol and 28% or less of monomethyl- and dimethyl-tertiarybutylphenols, a mixture of 55% or more of 2,4-dimethyl-6-tertiary-butylphenol, 15% of 2,6-ditertiarybutyl-4-methylphenol, and 30% or less of tertiary- and ditertiary-butylphenols, and the like can be added in the range of 17.0 mg/L or more and 24.0 mg/L or less.

To prevent accumulation of static electricity caused by friction of the aviation fuel oil with an inner wall of a pipe when the oil flows in a fuel pipe system at a high speed and to enhance electric conductivity, as the antistatic agent, STADIS450 made by Innospec Inc. or the like can be added at the initial amount in the range of 3 mg/L or less and the cumulative amount in the range of 5 mg/L or less. In this application, the initial amount means the amount of the additive to be added during production of the fuel oil, and the cumulative amount means the total cumulative amount of the additive added to the fuel oil before use.

To prevent the free metal component contained in the aviation fuel oil from reacting to make the fuel unstable, as the metal deactivator, N,N-disalicylidene-1,2-propanediamine or the like can be added such that the initial amount is in the range of 2 mg/L or less and the cumulative amount is in the range of 5.7 mg/L or less.

To prevent a slight amount of water contained in the aviation fuel oil from freezing to clog the pipe, as the deicing agent, ethylene glycol monomethyl ether or the like can be added in the range of 0.1 to 0.15% by volume.

Furthermore, any additive such as an antistatic agent, a corrosion suppressing agent, and a bactericide can be properly blended with the aviation fuel oil composition as long as within the scope of the present invention.

It is preferable that the aviation fuel oil composition satisfy the specified value specified in ASTM D7566-11 “Aviation turbine fuel oil” (“Jet A” or “Jet A-1”).

(Sulfur Content)

It is preferable that the sulfur content in the aviation fuel oil composition be 10 mass ppm or less, it is more preferable that the sulfur content be 8 mass ppm or less, and it is still more preferable that the sulfur content be 5 mass ppm or less from the viewpoint of corrosiveness. Also from the viewpoint of corrosiveness, it is preferable that the mercaptan sulfur content be 0.003% by mass or less, it is more preferable that the mercaptan sulfur content be 0.002% by mass or less, and it is still more preferable that the mercaptan sulfur content be 0.001% by mass or less. The sulfur content here means the value measured according to JIS K2541 “Crude oil and petroleum product sulfur content test method” and the mercaptan sulfur content means the value measured according to JIS K2276 “Mercaptan sulfur content test method (potentiometric titration method).”

(Freezing Point)

It is preferable that the freezing point of the aviation fuel oil composition be −47° C. or less, it is more preferable that the freezing point be −48° C. or less, and it is still more preferable that the freezing point be −50° C. or less from the viewpoint of preventing a reduction in feed of the fuel due to freezing of the fuel exposed to low temperatures during flying. The freezing point here means the value measured according to JIS K2276 “freezing point test method.”

(Density)

It is preferable that the density at 15° C. of the aviation fuel oil composition be 775 kg/m³ or more, and it is more preferable that the density at 15° C. be 780 kg/m³ or more from the viewpoint of a fuel consumption rate. It is preferable that the density at 15° C. be 839 kg/m³ or less, it is more preferable that the density at 15° C. be 830 kg/m³ or less, and it is still more preferable that the density at 15° C. be 820 kg/m³ or less from the viewpoint of combustibility. The density at 15° C. here means the value determined according to JIS K2249 “Crude oil and petroleum product-density test method and density-mass-volume conversion table.”

(Distillation Characteristics)

It is preferable that as the distillation characteristics of the aviation fuel oil composition, the 10% by volume distillation temperature (T10) be 205° C. or less, and it is more preferable that T10 be 200° C. or less from the viewpoint of evaporation properties. It is preferable that the end point (FEP) be 300° C. or less, and it is more preferable that the FEP be 298° C. or less from the viewpoint of combustion characteristics (burnout properties). The distillation characteristics here mean the value measured according to JIS K2254 “Petroleum product-distillation test method.”

(Existing Gum Content)

It is preferable that the existing gum content in the aviation fuel oil composition be 7 mg/100 mL or less, it is more preferable that the existing gum content be 5 mg/100 mL or less, and it is still more preferable that the existing gum content be 3 mg/100 mL or less from the viewpoint of preventing deficits due to generation of precipitates in a fuel introduction system or the like. The existing gum content here means the value measured according to JIS K2261 “Gasoline and aviation fuel oil existing gum test method.”

(Net Calorific Value)

It is preferable that the net calorific value of the aviation fuel oil composition be 42.8 MJ/kg or more, and it is more preferable that the net calorific value be 43 MJ/kg or more from the viewpoint of a fuel consumption rate. The net calorific value here means the value measured according to JIS K2279 “Crude oil and fuel oil calorific value test method.”

(Kinematic Viscosity)

It is preferable that the kinematic viscosity at −20° C. of the aviation fuel oil composition be 8 mm²/s or less, it is more preferable that the kinematic viscosity at −20° C. be 7 mm²/s or less, and it is still more preferable that the kinematic viscosity at −20° C. be 5 mm²/s or less from the viewpoint of the fluidity of the fuel pipe and achievement of uniform fuel jetting. The kinematic viscosity here means the value measured according to HS K2283 “Crude oil and petroleum product kinematic viscosity test method.”

(Corrosion of Copper Plate)

It is preferable that the corrosion of a copper plate by the aviation fuel oil composition be 1 or less from the viewpoint of the corrosiveness of the fuel tank and the pipe. The corrosion of copper plate here means the value measured according to JIS K2513 “Petroleum product-copper plate corrosion test method.”

(Aromatic Content)

It is preferable that the aromatic content in the aviation fuel oil composition be 25% by volume or less, and it is more preferable that the aromatic content be 20% by volume or less from the viewpoint of combustibility (prevention of generation of soot). Meanwhile, 8% by volume or more is preferable, 10% by volume or more is more preferable from the viewpoint of controlling of swelling properties of the rubber. The aromatic content here means the value measured according to JIS K2536 “Fuel oil hydrocarbon component test method (fluorescent indicator adsorption method).”

(Smoke Point)

It is preferable that the smoke point of the aviation fuel oil composition be 25 mm or more, it is more preferable that the smoke point be 27 mm or more, and it is still more preferable that the smoke point be 30 mm or more from the viewpoint of combustibility (prevention of generation of soot). The smoke point here means the value measured according to JIS K2537 “Fuel oil smoke point test method.”

(Flash Point)

It is preferable that the flash point of the aviation fuel oil composition be 40° C. or more, it is more preferable that the flash point be 42° C. or more, and it is still more preferable that the flash point be 45° C. or more from the viewpoint of safety. The flash point here means the value measured according to JIS K2265 “Crude oil and petroleum product-flash point test method-tag sealed flash point test method.”

(Total Acid Value)

It is preferable that the total acid value of the aviation fuel oil composition be 0.01 mgKOH/g or less, it is more preferable that the total acid value be 0.008 mgKOH/g or less, it is still more preferable that the total acid value be 0.005 mgKOH/g or less, and it is further still more preferable that the total acid value be 0.003 mgKOH/g or less from the viewpoint of corrosiveness. The total acid value here means the value measured according to JIS K2276 “Total acid value test method.”

(Thermal Stability)

It is preferable that as the thermal stability of the aviation fuel oil composition (at 260° C. for 2.5 hours), a pressure difference be 3.3 kPa or less, and a tube accumulation evaluation value (tube accumulation degree) be less than 3 from the viewpoint of, for example, preventing clogging of the fuel filter due to generation of precipitates during exposure to high temperatures. The pressure difference and the tube accumulation degree as the thermal stability here mean the values measured according to ASTM D3241 “Standard Test Method for Thermal Oxidation Stability of Aviation Turbine Fuels,” respectively.

(Conductivity)

It is preferable that the conductivity of the aviation fuel oil composition be 50 pS/m or more, and it is more preferable that the conductivity be 80 pS/m or more from the viewpoint of preventing charge. It is preferable that the conductivity be 600 pS/m or less, and it is more preferable that the conductivity be 500 pS/m or less from the viewpoint of ensuring separation of water. The conductivity here means the value measured according to JIS K2276 “Conductivity test method.”

(Lubricity)

It is preferable that the diameter of a wear track of the aviation fuel oil composition measured by the BOCLE test method be 0.85 mm or less, and it is more preferable that the diameter be 0.6 mm or less from the viewpoint of protecting the engine. The diameter of a wear track measured by the BOCLE test method means the value measured according to ASTM D5001 “Standard Test Method for Measurement of Lubricity of Aviation Turbine Fuels by the Ball-on-Cylinder Lubricity Evaluator (BOCLE).”

As above, a suitable embodiment according to the present invention has been described, but the present invention is not be limited to the embodiment.

In the present invention, the fuel oil base produced by the production method can also be used in applications other than the aviation fuel, and can be used in applications such as diesel engines, for example.

In the present invention, the fuel oil composition containing the fuel oil base produced by the production method can also be used in applications other than the aviation fuel, and can be used in applications such as diesel engines, for example.

In one aspect, the present invention can be a method for producing Euglena containing a wax ester in a high concentration, the method comprising a first step of aerobically culturing a microalga Euglena under a nitrogen-deficient condition; and a second step of keeping the cells under an anaerobic condition, wherein at least the two steps are performed, and prior to the second step, a nutrient is added to the culture solution subjected to the first step.

In other aspect, the present invention can also be a method for producing a fuel oil base, comprising a first step of aerobically culturing a microalga Euglena under a nitrogen-deficient condition; a second step of keeping the cells under an anaerobic condition; and a third step of hydrotreating a raw material oil containing the wax ester generated in the second step to produce a fuel oil base, wherein at least the three steps are performed, and prior to the second step, a nutrient is added to the culture solution subjected to the first step.

The production methods may be characterized in that the addition of the nutrient is performed at a timing earlier than the timing when the dissolved oxygen concentration of the culture solution kept under an anaerobic condition in the second step is reduced to 0.03 mg/L or less.

### EXAMPLES

Hereinafter, the present invention will be described in more detail based on Examples and Comparative Examples, but the present invention will not be limited to these Examples.

(Preparation of Catalyst)

<Catalyst A>

18.0 g of water glass No. 3 was added to 3000 g of an aluminate sodium aqueous solution having a concentration of 5% by mass, and the solution was placed in a container kept at 65° C. In another container kept at 65° C., 6.0 g of phosphoric acid (concentration: 85%) was added to 3000 g of an aluminum sulfate aqueous solution having a concentration 2.5% by mass to prepare a solution; to this, the aqueous solution containing the above aluminate sodium was dropped. The end point was defined as when the pH of the mixed solution reached 7.0; the prepared slurry product was filtered through a filter to obtain a cake-like slurry.

The cake-like slurry was placed in a container to which a reflux cooler was attached, 150 ml of distilled water and 10 g of 27% aqueous ammonia solution were added, and these were stirred at 75° C. for 20 hours while heating. The slurry was placed in a kneading apparatus, and heated to 80° C. or more; the slurry was kneaded while the moisture content was being removed to prepare a clay-like kneaded product. The prepared kneaded product was extruded with an extrusion molding machine into a cylindrical shape having a diameter of 1.5 mm; the product was dried at 110° C. for one hour, and then was calcined at 550° C. to prepare a molded carrier.

50 g of the prepared molded carrier was placed in a recovery flask; while degassing with a rotary evaporator, an impregnation solution containing 17.3 g of molybdenum trioxide, 13.2 g of nickel(II) nitrate hexahydrate, 3.9 g of phosphoric acid (concentration: 85%), and 4.0 g of malic acid was injected into the flask. The impregnated sample was dried at 120° C. for one hour, and was then calcined at 550° C. to prepare Catalyst A. The physical properties of Catalyst A are shown in Table 3.

<Catalyst B>

50 g of a silica alumina carrier having a silica-alumina ratio (mass ratio) of 70:30 was placed in recovery flask; while degassing with a rotary evaporator, a tetraammine platinum(II) chloride aqueous solution was injected into the flask. The impregnated sample was dried at 110° C., and was then calcined at 350° C. to prepare Catalyst B. The amount of platinum carried on Catalyst B was 0.5% by mass based on the total amount of the catalyst. The physical properties of Catalyst B are shown in Table 3.

<Catalyst C>

ZSM-48 zeolite was synthesized by the method described in Non Patent Literature (Appl. Catal. A, 299 (2006), pp. 167-174). The synthesized ZSM-48 zeolite was dried under an air stream at 95° C. for 3 hours, and was then calcined under an air atmosphere at 550° C. for 3 hours to prepare calcined zeolite.

As an alumina binder, a commercially available boehmite powder (trade name: CATALOID-AP) was prepared. The calcined zeolite was sufficiently kneaded with the boehmite powder formed into a slurry by adding a proper amount of water such that zeolite: alumina was 70:30 (% by mass); thus, a kneaded product was prepared. The kneaded product was fed to an extrusion molding machine to prepare a molded carrier having a cylindrical shape (diameter: 1.5 mm, length: 1 cm). The prepared molded carrier was dried under an air stream at 95° C. for 3 hours, and was then calcined under an air atmosphere at 550° C. for 3 hours.

50 g of the calcined molded carrier was placed in a recovery flask; while degassing with a rotary evaporator, dinitrodiamino platinum and dinitrodiamino palladium were added, and were impregnated into the molded carrier to prepare an impregnated sample. The amounts of impregnation were adjusted such that the amounts of platinum and palladium impregnated were 0.3% by mass and 0.3% by mass based on the catalyst to be prepared, respectively. The impregnated sample was dried under an air atmosphere at 120° C. for one hour, and was then calcined under an air atmosphere at 550° C. to prepare Catalyst C. The physical properties of Catalyst C are shown in Table 3.

TABLE 3

| | | Cata- | Cata- | Cata- |
|---|---|---|---|---|
| | | lyst A | lyst B | lyst C |
| Al₂O₃ Content | (% by mass, based | 91.2 | 30 | 30 |
| | on mass of carrier) | | | |
| SiO₂ Content | (% by mass, based | 4.8 | 70 | 0 |
| | on mass of carrier) | | | |
| P₂O₅ Content | (% by mass, based | 4 | 0 | 0 |
| | on mass of carrier) | | | |
| Content of crystalline | (% by mass, based | — | — | 70 |
| substance | on mass of carrier) | | | |
| Name of crystalline | | — | — | [symbol] MRE |
| substance | | | | (ZSM-48) |
| MoO₃ Content | (% by mass, based | 24 | 0 | 0 |
| | on mass of catalyst) | | | |
| NiO Content | (% by mass, based | 2.6 | 0 | 0 |
| | on mass of catalyst) | | | |
| Pt Content | (% by mass, based | 0 | 0.5 | 0.3 |
| | on mass of catalyst) | | | |
| Pd Content | (% by mass, based | 0 | 0 | 0.3 |
| | on mass of catalyst) | | | |

[symbol]

indicates data missing or illegible when filed

### Example 1

### (1-1) Pre-Culturing Step

The AY culture medium having the composition shown in Table 1 was prepared with deionized water, the pH was adjusted to 3.5 with dilute sulfuric acid, and autoclave sterilization was performed. Approximately 2 L of the sterilized AY culture medium was placed 20 cm high in an acrylic culturing container measuring a length of 10 cm, a width of 10 cm, and a height of 27 cm, and Euglena gracilis Z strains were planted in the medium.

The culturing container was placed inside of a thermostat water bath installed on a magnetic stirrer SRSB10LA (ADVANTEC Co., LTD.), and the medium was stirred at a strength of 300 rpm using a 6 cm stirrer. A metal halide lamp Eye Clean Ace BT (made by Iwasaki Electric Co., Ltd.) as a light source was placed immediately above the surface of the culture solution, and its height was adjusted such that the light illuminating the surface of the culture solution had an intensity of approximately 900 μmol/(m²·s). The light irradiation time employed the light and dark cycle in which light was turned on for 12 hours and then turned off for 12 hours to make the condition close to the outdoor condition of day and night. As a carbon source, CO₂ was flowed at a flow rate of 0.1 vvm (200 mL/min) and a concentration of 15%.

After the pre-culturing was performed for 3 days using the AY culture medium, Euglena cells were centrifuged from the 2 L culture solution (2500 rpm, 5 minutes, room temperature), and were washed with deionized water once to obtain nitrogen-deficient cultured algal bodies.

### (1-2) Nitrogen-Deficient Culturing Step (First Step)

The AY culture medium having the composition shown in Table 2 (hereinafter referred to as “nitrogen-deficient AY culture medium” in some cases) was prepared with deionized water, the pH was adjusted to 3.5 with dilute sulfuric acid, and autoclave sterilization was performed. Approximately 4.5 L of the sterilized nitrogen-deficient AY culture medium was placed 20 cm high in an acrylic culturing container measuring a length of 15 cm, a width of 15 cm, and a height of 27 cm; the algal bodies obtained in (1-1) Pre-culturing step were planted in the medium such that the initial concentration of the algal bodies in the nitrogen-deficient AY culture medium was 0.3 g/L.

The culturing container was placed inside of a thermostat water bath installed on a magnetic stirrer SRSB10LA (ADVANTEC Co., LTD.), and the medium was stirred at a strength of 300 rpm using a 6 cm stirrer. A metal halide lamp Eye Clean Ace BT (made by Iwasaki Electric Co., Ltd.) as a light source was placed immediately above the surface of the culture solution, and its height was adjusted such that the light illuminating the surface of the culture solution had an intensity of approximately 900 μmol/(m²·s). The light irradiation time employed the light and dark cycle in which light was turned on for 12 hours and then turned off for 12 hours to make the condition close to the outdoor condition of day and night. As a carbon source, CO₂ was flowed at a flow rate of 0.1 vvm (200 mL/min) and a concentration of 15%.

The culturing was performed in a light and dark cycle in which the start of the dark period was defined as the start of culturing, i.e., 0 hour; the metal halide lamp was turned on after 12 hours, turned off after 24 hours, and turned on after 36 hours again.

### (1-3) Anaerobic Fermentation Step (Second Step)

After 47 hours from the start of the culturing in the nitrogen-deficient AY culture medium, 0.1643 g (equivalent to 10 mg/L) of diammonium hydrogenphosphate ((NH₄)₂HPO₄) as the nutrient was added to 1 L of the culture solution.

Next, after 48 hours from the start of the culturing in the nitrogen-deficient AY culture medium, 2 L of the culture solution was condensed with a centrifuge into 0.5 L, and the condensed solution was placed in a tall beaker having a volume of 600 mL. The condensed culture solution was subjected to an anaerobic treatment by flowing nitrogen gas at a flow rate of 200 mL/min for approximately 30 minutes. The anaerobic treatment was terminated when it was found that the dissolved oxygen concentration reached 0.01 mg/L or less.

The top of the beaker after the anaerobic treatment was covered with paraffin, and the entire flask was covered with an aluminum foil to shield against light, and was left to stand at room temperature for 3 days to perform anaerobic fermentation. At this time, room temperature was 26 to 27° C. After the anaerobic fermentation, Euglena cells were recovered with a centrifugation (2500 rpm, 5 minutes, room temperature); the recovered products were frozen, and were freeze dried to obtain Euglena dried algal bodies. The freeze drying was performed with a freeze dryer DRW240DA (ADVANTEC Co., LTD.).

### (1-4) Extraction of Oils and Fats

Extraction of oils and fats from the Euglena dried algal bodies was performed by the following procedure. First, 0.2 to 0.3 g of the Euglena dried algal bodies was placed in a sealed container, n-hexane having a weight 10 times that of the Euglena dried algal bodies was added, and the mixture was shaken at room temperature (25 to 26° C.) and 200 rpm for one hour. A solid was separated from a liquid by filtration, and the cake on the funnel was washed with hexane having a weight approximately 20 times that of the original dried algal bodies. The filtrate and the washing liquid were added, and n-hexane was distilled with an evaporator whose bath temperature was set at 55° C.; then, oils and fats were recovered.

The operation was repeated twice, the first and second extracted oils and fats were collected into one. From the weight of the recovered oils and fats and the weight of the Euglena dried algal bodies used in extraction with hexane, the content of oils and fats in the Euglena dried algal bodies after the anaerobic fermentation was calculated. The content of the oils and fats is as shown in Table 4.

<Component Analysis of Oils and Fats 1>

The oils and fats obtained in (1-4) were subjected to gel permeation chromatography (GPC) analysis by the following procedure.

10 mL of chloroform was added to the produced oils and fats to dissolve the oils and fats, and the solution was filtered to prepare a measurement solution. Allience2695 (Waters) was used as the HPLC system, and two columns G3000H8 (upstream, made by Tosoh Corporation) and G2000H8 (downstream, made by Tosoh Corporation) were connected in series.

The measurement was performed under the conditions of a column temperature of 23° C., a flow rate of 1 mL/min, a concentration of 1.0% by mass, and an injection amount of 100 μL, and RI was used as a detector. The calibration curve was created using standard samples of n-paraffin up to C₄₀H₈₂. The molecular weight and the retention time are in a linear relationship.

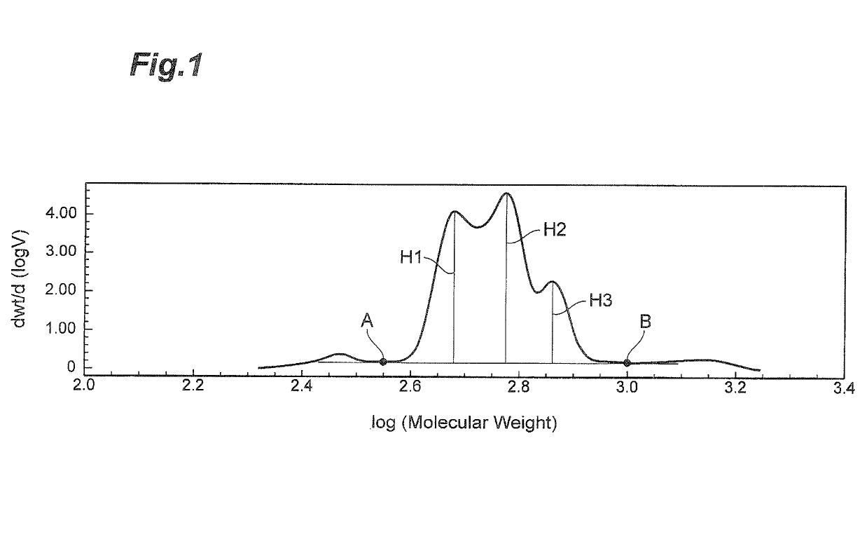

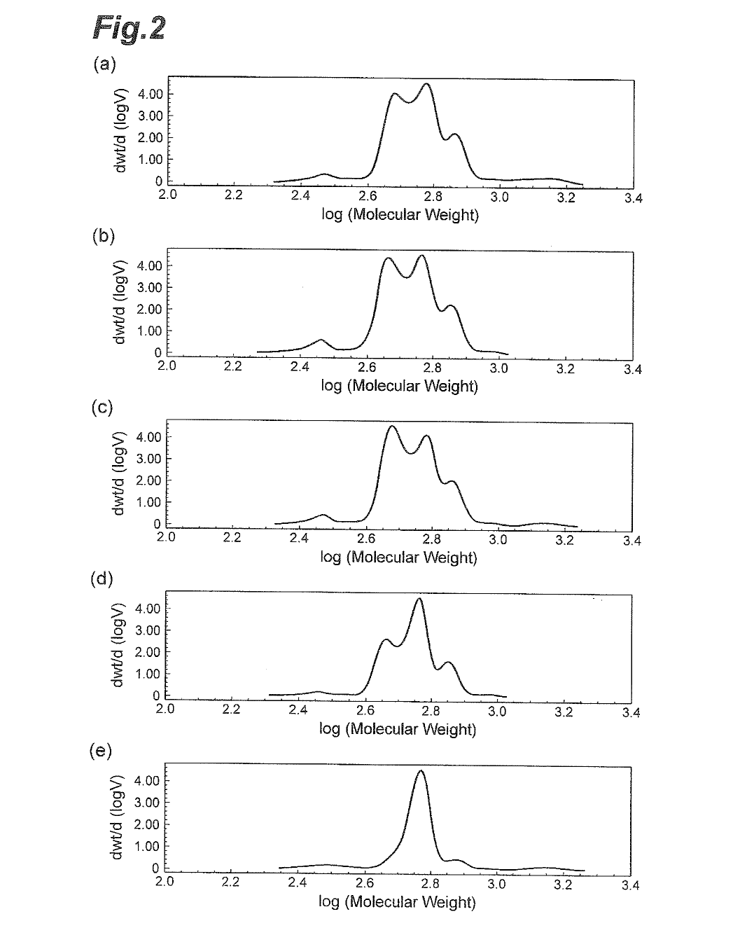

Based on the measurement results, a graph whose abscissa was logarithmic (molecular weight) was created. The graphs created are shown in FIG. 1 and FIG. 2(a). In the graphs created, the peak having the highest point in the range of 2.63 to 2.70 in the abscissa is the peak derived from the wax ester, the peak having the highest point in the range of 2.73 to 2.80 in the abscissa is the peak derived from diglyceride, the peak having the highest point in the range of 2.83 to 2.90 in the abscissa is the peak derived from triglyceride. The value calculated by the following method from the graphs created was defined as an index for the content of the wax ester.

In the graphs created, Point A at 2.55 in the abscissa was connected to Point B at 3.00 in the abscissa with a straight line, which was defined as a baseline. From the height H1 between the highest point in the range of 2.63 to 2.70 in the abscissa and the baseline, the height H2 between the highest point in the range of 2.73 to 2.80 in the abscissa and the baseline, and the height H3 between the highest point in the range of 2.83 to 2.90 in the abscissa and the baseline, the content of the wax ester was calculated from the following expression. The calculated value is as shown in Table 4.

content of wax ester (%)={H1/(H1+H2+H3)}×100

It is preferable that the content of the wax ester calculated by the above procedure be 33% or more, it is more preferable that the content of the wax ester be 35% or more, and it is still more preferable that the content of the wax ester be 37% or more.

<Component Analysis of Oils and Fats 2>

In the oils and fats obtained in (1-4), the results of component analysis shown in Table 4 will be shown below in detail.

Density at 15° C. (density@15° C.) means the value measured according to JIS K2249 “Crude oil and petroleum product-density test method and density·mass·volume conversion table.”

C (% by mass) and H (% by mass) in Elemental analysis mean the values measured by the method specified in ASTM D 5291 “Standard Test Methods for Instrumental Determination of Carbon, Hydrogen, and Nitrogen in Petroleum Products and Lubricants.”

Oxygen content means the value measured by the method such as UOP 649-74 “Total Oxygen in Organic Materials by Pyrolysis-Gas Chromatographic Technique.”

Sulfur content means the value measured according to JIS K2541 “Crude oil and petroleum product sulfur content test method.”

### (1-5) Hydrotreating Step (Third Step)

A reaction tube (inner diameter: 20 mm) filled with Catalyst A (100 ml) was mounted on a fixed bed flow reaction apparatus countercurrently. Subsequently, using a straight run gas oil (sulfur content: 3% by mass) to which dimethyl disulfide was added, the catalyst was pre-sulfidized under the conditions of a catalyst layer average temperature of 300° C., a hydrogen partial pressure of 6 MPa, a liquid hourly space velocity of 1 h⁻¹, and a hydrogen/oil ratio of 200 NL/L for 4 hours.

After the pre-sulfidation, part of the hydrogenated oil after introduction thereof into a high pressure separator described later was recycled to the oils and fats obtained in (1-4) at an amount of 1 by mass times the mass of the oils and fats, and dimethyl sulfide was added such that the content of the sulfur content (in terms of the sulfur atom) was 10 mass ppm based on the total amount of a raw material oil; thus, the raw material oil was prepared.

The condition for hydrotreating was that the catalyst layer average temperature (reaction temperature) was 300° C., the hydrogen pressure was 6.0 MPa, the liquid hourly space velocity was 1.0 h⁻¹, and the hydrogen/oil ratio was 510 NL/L. The treated oil after the hydrotreating was introduced into the high pressure separator, and hydrogen, hydrogen sulfide, carbon dioxide, and water were removed from the treated oil.

Part of the hydrogenated oil after introduction into the high pressure separator was cooled to 40° C. with cooling water to be recycled to the oils and fats obtained in (1-4), as described above. The remaining hydrogenated oil after the recycling was introduced into a fixed bed flow reaction apparatus (isomerization apparatus) with a reaction tube (inner diameter: 20 mm) filled with Catalyst B (150 ml), and was subjected to a hydroisomerization treatment. First, Catalyst B was subjected to a reduction treatment under the conditions of a catalyst layer average temperature of 320° C., a hydrogen pressure of 3 MPa, and a hydrogen gas amount of 83 ml/min for 6 hours, and then the hydroisomerization treatment was performed under the conditions of a catalyst layer average temperature (reaction temperature) of 320° C., a hydrogen pressure of 3 MPa, a liquid hourly space velocity of 1.0 h⁻¹, and a hydrogen/oil ratio of 500 NL/L.

The hydroisomerized oil after the isomerization treatment was introduced into a rectifying column to be fractionated into a light fraction having a boiling point in the range of less than 140° C., an intermediate fraction having an boiling point of 140 to 300° C., and a heavy fraction having a boiling point more than 300° C. Among these, the intermediate fraction having a boiling point of 140 to 300° C. was used as Fuel oil base 1. The hydrotreating conditions, the hydroisomerization treatment conditions, and the characteristics of Fuel oil base 1 produced are shown in Tables 5 and 6.

In Table 5, “Isomerization rate 1” in the hydroisomerized oil after the isomerization treatment means the content of isoparaffin having one or more branchings (% by mass), and “Isomerization rate 2” means the content of isoparaffin having two or more branchings (% by mass). Isomerization rate 1 and Isomerization rate 2 each are the values measured by a gas chromatograph and a time of flight mass spectrometer. “Fuel oil base yield” means the yield of the intermediate fraction having a boiling point of 140 to 300° C. based on the total amount of the hydroisomerized oil after the isomerization treatment.

### Example 2

In the above (1-3) Anaerobic fermentation step, oils and fats were produced by the same method as that in Example 1 except that as the nutrient, 1 g of glucose was added per 1 L culture solution instead of diammonium hydrogenphosphate. The produced oils and fats were subjected to component analysis by the same method as that in Example 1. The results of component analysis are as shown in FIG. 2(b) and Table 4.

The produced oils and fats were subjected to the hydrotreating step by the same method as that in Example 1 to produce Fuel oil base 2. The hydrotreating conditions, the hydroisomerization treatment conditions, and the characteristics of Fuel oil base 2 produced are shown in Tables 5 and 6.

### Example 3

In the above (1-3) Anaerobic fermentation step, oils and fats were produced by the same method as that in Example 1 except that as the nutrient, 1 g of glucose was added per 1 L culture solution and 0.1643 g (equivalent to 10 mg/L) of diammonium hydrogenphosphate ((NH₄)₂HPO₄) was added per 1 L culture solution. The produced oils and fats were subjected to component analysis by the same method as that in Example 1. The results of component analysis are as shown in FIG. 2(c) and Table 4.

The oils and fats produced were subjected to hydrotreating by the same method as that in Example 1 to produce Fuel oil base 3. The hydrotreating conditions, the hydroisomerization treatment conditions, and the characteristics of Fuel oil base 3 produced are shown in Tables 5 and 6.

### Example 4

The oils and fats produced by the same method as that in Example 3 were subjected to hydrotreating by the same method as that in Example 1 except that Catalyst C was used instead of Catalyst B; thus, Fuel oil base 4 was produced. The hydrotreating conditions, the hydroisomerization treatment conditions, and the characteristics of Fuel oil base 4 produced are shown in Tables 5 and 6.

### Comparative Example 1

In the above (1-3) Anaerobic fermentation step, oils and fats were produced by the same method as that in Example 1 except that the nutrient was not added. The oils and fats produced were subjected to component analysis by the same method as that in Example 1. The results of component analysis are as shown in FIG. 2(d) and Table 4.

The oils and fats produced were subjected to hydrotreating by the same method as that in Example 1 to produce Fuel oil base a. The hydrotreating conditions, the hydroisomerization treatment conditions, and the characteristics of Fuel oil base a produced are shown in Tables 5 and 6.

### Comparative Example 2

After 48 hours from the start of the culturing in the nitrogen-deficient AY culture medium in the above (1-2) Nitrogen-deficient culturing step, Euglena cells were recovered by centrifugation (2500 rpm, 5 minutes, room temperature); the recovered product was frozen, and was freeze dried to obtain Euglena dried algal bodies. In the obtained Euglena dried algal bodies, oils and fats were extracted by the same method as that in (1-4), and the produced oils and fats were subjected to component analysis by the same method as that in Example 1. The results of component analysis are as shown in FIG. 2 (e) and Table 4.

The oils and fats produced were subjected to hydrotreating by the same method as that in Example 1 to produce Fuel oil base b. The hydrotreating conditions, the hydroisomerization treatment conditions, and the characteristics of Fuel oil base b produced are shown in Tables 5 and 6.

### Examples 5 to 9

Fuel oil bases 1 to 4 produced in Examples each were mixed with a commercially available petroleum aviation fuel oil base to prepare fuel oil compositions shown in Table 7. Any one of the fuel oil compositions satisfied aviation turbine fuel oil “Jet A, Jet A-1” specified in ASTM D7566-11, and fuel oil compositions suitable for the aviation fuel were produced. Typical characteristics of the fuel oil composition shown in Table 7 are the values measured by the above methods, respectively.

In Table 7, Antioxidant represents 2,6-ditert-butyl phenol, Antistatic agent represents “STADIS450” (made by Innospec Inc.), and Corrosion inhibitor represents “OCTEL DCI-4A” (made by Octel Company Ltd.).

TABLE 4

| | | | | | Comparative | Comparative |
|---|---|---|---|---|---|---|
| | | Example 1 | Example 2 | Example 3 | Example 1 | Example 2 |
| Content of oils and fats % | | 36 | 52 | 58 | 38 | 26 |
| Content of wax ester % | | 37.5 | 39.2 | 42.9 | 29.6 | 14.9 |
| Density@15° C. (g/cm³) | | 0.8422 | 0.8418 | 0.8417 | 0.8414 | 0.8405 |
| Elemental analysis | C (% by mass) | 78.7 | 78.5 | 78.8 | 78.5 | 78.4 |
| | H (% by mass) | 13.1 | 13.1 | 13.0 | 13.2 | 13.2 |

| | | | | | |
|---|---|---|---|---|---|
| Oxygen content (% by mass) | 8.0 | 8.1 | 7.9 | 8.1 | 8.2 |
| Sulfur content (mass ppm) | 8 | 7 | 8 | 12 | 13 |

TABLE 5

| | | | | | | Comparative | Comparative |
|---|---|---|---|---|---|---|---|
| | | Example 1 | Example 2 | Example 3 | Example 4 | Example 1 | Example 2 |
| hydrotreating | Catalyst | Catalyst A | Catalyst A | Catalyst A | Catalyst A | Catalyst A | Catalyst A |
| | Reaction temperature (° C.) | 300 | 300 | 300 | 300 | 300 | 300 |
| | Hydrogen/oil ratio | 510 | 510 | 510 | 510 | 510 | 510 |
| | (NL./L) | | | | | | |
| | Hydrogen pressure (MPa) | 6 | 6 | 6 | 6 | 6 | 6 |
| | LHSV (h⁻¹) | 1.0 | 1.0 | 1.0 | 1.0 | 1.0 | 1.0 |
| | Recycling amount (times by | 1 | 1 | 1 | 1 | 1 | 1 |
| | mass) | | | | | | |
| hydroisomerization | Catalyst | Catalyst B | Catalyst B | Catalyst B | Catalyst C | Catalyst B | Catalyst B |
| treatment | Reaction temperature (° C.) | 320 | 320 | 320 | 320 | 320 | 320 |
| | Hydrogen/oil ratio (NL./L) | 500 | 500 | 500 | 500 | 500 | 500 |
| | Hydrogen pressure (MPa) | 3 | 3 | 3 | 3 | 3 | 3 |
| | LHSV (h⁻¹) | 1.0 | 1.0 | 1.0 | 1.0 | 1.0 | 1.0 |
| | Isomerization rate 1 (% by | 86 | 90 | 88 | 91 | 85 | 85 |
| | mass) | | | | | | |
| | Isomerization rate 2 (% by | 21 | 23 | 21 | 24 | 20 | 19 |
| | mass) | | | | | | |

| | | | | | | |
|---|---|---|---|---|---|---|
| Fuel oil base (% by mass) | 47 | 48 | 55 | 56 | 32 | 11 |

TABLE 6

| | | | | | | Comparative | Comparative |
|---|---|---|---|---|---|---|---|
| | | Example 1 | Example 2 | Example 3 | Example 4 | Example 1 | Example 2 |
| | | Fuel oil | Fuel oil | Fuel oil | Fuel oil | Fuel oil | Fuel oil |
| | | base 1 | base 2 | base 3 | base 4 | base a | base b |
| Distillation | T10 (° C.) | 153.0 | 152.0 | 153.0 | 153.5 | 153.0 | 153.5 |
| characteristics | T50 (° C.) | 198.5 | 198.0 | 199.0 | 198.5 | 198.0 | 197.5 |
| | T90 (° C.) | 276.5 | 276.0 | 276.0 | 277.0 | 276.5 | 277.0 |
| | FEP (° C.) | 297.5 | 297.0 | 297.5 | 298.0 | 297.5 | 298.5 |
| | T90 − T10 (° C.) | 123.5 | 124.0 | 123.0 | 123.5 | 123.5 | 123.5 |
| Total acid value (mgKOH/g) | | 0.002 | 0.001 | 0.001 | 0.002 | 0.002 | 0.002 |
| Flash point (° C.) | | 84 | 85 | 83 | 85 | 84 | 85 |
| Density@15° C. (kg/m³) | | 760 | 769 | 763 | 763 | 771 | 772 |
| Freezing point (° C.) | | −51 | −52 | −52 | −51 | −51 | −52 |
| Existing gum content (mg/100 mL) | | 4 | 3 | 3 | 2 | 5 | 5 |
| Thermal stability | Pressure | 0 | 0 | 0 | 0 | 0 | 0 |
| (325° C., 2.5 hours) | difference (KPa) | | | | | | |
| | Tube | 0 | 0 | 0 | 0 | 0 | 0 |
| | accumulation | | | | | | |
| | degree | | | | | | |

| | | | | | | |
|---|---|---|---|---|---|---|
| Aromatic content (% by mass) | <0.1 | <0.1 | <0.1 | <0.1 | <0.1 | <0.1 |
| Cycloparaffin content (% by mass) | 1 | 1 | 1 | 1 | 2 | 2 |
| Olefin content (% by mass) | <0.1 | <0.1 | <0.1 | <0.1 | <0.1 | <0.1 |
| Sulfur content (mass ppm) | <1 | <1 | <1 | <1 | <1 | <1 |
| Oxygen content (% by mass) | <0.1 | <0.1 | <0.1 | <0.1 | <0.1 | <0.1 |
| Nitrogen content (mass ppm) | <1 | <1 | <1 | <1 | <1 | <1 |
| Moisture content (mass ppm) | 22 | 20 | 18 | 18 | 23 | 22 |
| Chlorine content (mass ppm) | <1 | <1 | <1 | <1 | <1 | <1 |
| Metal content (mass ppm) | <0.1 | <0.1 | <0.1 | <0.1 | <0.1 | <0.1 |

In Table 6, Metal content (mass ppm) represents the largest value of each metal content (mass ppm) of Al, Ca, Co, Cr, Cu, Fe, K, Mg, Mn, Na, Ni, P, Pb, Pd, Pt, Sn, Sr, Ti, V, or Zn. Namely, a metal content (mass ppm) of “<0.1” represents each metal content of 0.1 mass ppm or less.

TABLE 7

| | | | | | | | Reference |
|---|---|---|---|---|---|---|---|
| | | Example 5 | Example 6 | Example 7 | Example 8 | Example 9 | Example |
| Blending proportion | Fuel oil base 1 (% by | 50 | — | — | — | 5 | — |
| | volume) | | | | | | |
| | Fuel oil base 2 (% by | — | 40 | — | — | — | — |
| | volume) | | | | | | |
| | Fuel oil base 3 (% by | | — | 30 | — | — | — |
| | volume) | | | | | | |
| | Fuel oil base 4 (% by | — | — | — | 20 | — | — |
| | volume) | | | | | | |
| | Commercially available | 50 | 60 | 70 | 80 | 95 | 100 |
| | petroleum aviation fuel oil | | | | | | |
| | base (% by volume) | | | | | | |
| | Antioxidant (mg/L) | 20 | 20 | 20 | 20 | 20 | 20 |
| | Antistatic agent (mg/L) | 1 | 1 | 1 | 1 | 1 | 1 |
| | Corrosion inhibitor (mg/L) | 10 | 10 | 10 | 10 | 10 | 10 |
| Distillation | T10 (° C.) | 155.0 | 158.0 | 160.0 | 160.0 | 162.0 | 165.0 |
| characteristics | T50 (° C.) | 198.0 | 198.5 | 195.0 | 194.5 | 193.0 | 192.0 |
| | T90 (° C.) | 255.0 | 253.0 | 250.0 | 248.0 | 240.0 | 237.0 |
| | FEP (° C.) | 296.5 | 298.0 | 295.0 | 295.5 | 290.0 | 257.5 |
| Total acid value (mgKOH/g) | | 0.002 | 0.002 | 0.002 | 0.003 | 0.003 | 0.003 |
| Flash point (° C.) | | 51 | 50 | 50 | 48 | 46 | 44 |
| Density@15° C. (kg/m³) | | 786 | 795 | 797 | 802 | 809 | 812 |
| Kinematic viscosity@−20° C. (mm²/s) | | 4.690 | 4.320 | 4.223 | 4.015 | 3.594 | 3.496 |
| Freezing point (° C.) | | −51 | −52 | −52 | −51 | −51 | −67.5 |
| Existing gum content (mg/100 mL) | | 2 | 2 | 2 | 1 | 1 | 1 |
| Net calorific value (MJ/kg) | | 43.0 | 43.0 | 43.0 | 43.1 | 43.1 | 43.1 |
| Corrosion of copper plate | | 1 | 1 | 1 | 1 | 1 | 1 |
| Thermal stability | Pressure difference (KPa) | 0 | 0 | 0 | 0 | 0 | 0 |
| (325° C., 2.5 hours) | Tube accumulation degree | 0 | 0 | 0 | 0 | 0 | 0 |

| | | | | | | |
|---|---|---|---|---|---|---|
| Aromatic content (% by mass) | 10 | 12 | 14 | 16 | 19 | 20 |
| Smoke point (mm) | 30 | 28 | 28 | 27 | 25 | 22 |
| Sulfur content (mass ppm) | 1 | 1 | 1 | 1 | 1 | 2 |
| Conductivity (pS/m) | 230 | 250 | 250 | 280 | 300 | 340 |
| Diameter of a wear track by BOCLE test method | <0.85 | <0.85 | <0.85 | <0.85 | <0.85 | <0.85 |
| (mm) | | | | | | |

1. A method for producing a fuel oil base, comprising:
a first step of aerobically culturing a microalga Euglena under a nitrogen-deficient condition;
a second step of adding a nutrient to a treatment solution containing the microalga Euglena cultured in the first step, adjusting a dissolved oxygen concentration of the treatment solution to 0.03 mg/L or less, and performing anaerobic fermentation of the microalga Euglena to produce a wax ester; and
a third step of hydrotreating a raw material oil containing the wax ester to produce a fuel oil base.

2. The production method according to claim 1, wherein the second step is a step of adjusting the dissolved oxygen concentration of the treatment solution to 0.03 mg/L or less within 3 hours after the nutrient is added to the treatment solution.

3. The production method according to claim 1, wherein the nutrient contains a nitrogen source.

4. The production method according to claim 3, wherein the nitrogen source contains an ammonium compound.

5. The production method according to claim 1, wherein the nutrient contains a carbon source.

6. The production method according to claim 5, wherein the carbon source contains glucose.

7. The production method according to claim 1, wherein the third step includes a hydrorefining treatment and a hydroisomerization treatment as the hydrotreating.

8. A fuel oil base produced by the production method according to claim 1.

9. A method for producing a fuel oil composition, comprising a step of producing a fuel oil composition having a sulfur content of 10 mass ppm or less and a freezing point of −47° C. or less using the fuel oil base produced by the production method according to claim 1.

10. The method for producing a fuel oil composition according to claim 9, wherein the fuel oil composition contains 1 to 50% by volume of the fuel oil base.

11. The method for producing a fuel oil composition according to claim 9, wherein the fuel oil composition contains at least one additive selected from an antioxidant, an antistatic agent, a metal deactivator, and a deicing agent.

12. The method for producing a fuel oil composition according to claim 9, wherein the fuel oil composition satisfies specification values for an aviation turbine fuel oil specified in ASTM D7566-11.

13. A fuel oil composition produced by the production method according to claim 9.
